(19) United States
(12) Patent Application Publication
(10) Pub. No.: US 2003/0132860 A1
(43) Pub. Date: Jul. 17, 2003

(54) Interface for visual cueing and control for tactical flightpath management

(75) Inventors: Thea L. Feyereisen, Hudson, WI (US); Chad L. Cundiff, Phoenix, AZ (US); Ou Zhao, Overland Park, KS (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc., Morristown, NJ

(21) Appl. No.: 10/252,029

(22) Filed: Sep. 20, 2002

Related U.S. Application Data
(60) Provisional application No. 60/324,241, filed on Sep. 21, 2001.

(51) Int. Cl. G01C 23/00

(52) U.S. Cl. 340/973; 340/963

(57) ABSTRACT

An apparatus, method and computer program product for an integrated display presentation for tactical flight path management that simplifies instrument flight by replicating many of the cues basic to visual flight using spatial flow, integrating navigation information conformal symbology, and improving instrumentation using an enhanced “T” instrument display.

This application claims the benefit of U.S. Provisional Application Serial No. 60/324,241, filed in the names of Thea L. Feyereisen, Chad L. Cundiff and Ou Zhao on Sep. 21, 2001, the complete disclosure of which is incorporated herein by reference.

Related patent applications include co-pending U.S. patent application Ser. No. 10/052,716, entitled SIMULATED VISUAL GLIDESLOPE INDICATOR ON AIRCRAFT DISPLAY, filed in the name of Charles L. Hett on Jan. 17, 2002 and co-pending U.S. patent application Ser. No. ______ (Attorney Docket Number H0001712), entitled PICTOGRAPHIC MODE AWARENESS DISPLAY FOR AIRCRAFT, filed in the name of Thea L. Feyereisen on Aug. 30, 2002, all assigned to the assignee of the present application and incorporated in their entirety herein by reference.

### FIELD OF THE INVENTION

The present invention relates to cockpit display devices and methods, and in particular to integrated display presentation devices for tactical flight path management that use spatial flow, conformal navigation information, and dynamic instrument presentation.

### BACKGROUND OF THE INVENTION

The “human factor” has been and remains the dominant cause of accidents in General Aviation (GA). Current accident statistics indicate the primary causes of fatal accidents across all GA classes are: maneuvering flight, take-off/initial climb, weather, and approach.

FIG. 1 illustrates one embodiment of NASA-sponsored “Highway in the Sky” (HITS) display format embodied in a cockpit display 1. HITS is an affordable glass cockpit technology that is being developed to improve the safety and ease of GA flying. See, AGATE Flyer (2000). Conventional glass cockpit technology is operated by onboard automation to provide a semblance of perspective by displaying a horizon line 3 on a narrow horizontal and vertical field of view (FOV). A partial compass rose 5 is centered on the display and spread along the horizon line 3 as compass angle ticks 7. Currently, the standard electromechanical “T” configuration in conventional head-down cockpit displays provides flight data parameters such as air speed (AS) 9, wind direction and velocity 10, true air speed (TAS) 11, DME to next waypoint 12, and altitude 13 displayed using conventional electromechanical instruments having analog needle pointers or digital readouts. The standard electromechanical “T” configuration may also include other instruments, such as a turn coordinator, a heading indicator, and a vertical speed indicator.

The HITS technology is operated by the onboard automation to provide a series of rectangular boxes 15a, 15b through 15n, also known as “paving stones,” “goal posts,” and by other sobriquets. These boxes 15a-15n are depicted along a three-dimensional (3-D) flight plan 17 and form a visual “tunnel” 19 for the pilot to fly through. The HITS technology requires that a 3-D flight plan is stored in the onboard automation to generate the tunnel 19. Unfortunately, a majority of both GA navigation systems and pilots flying today do not store this information. Nor is the Federal Aviation Administration/Air Traffic Control (FAA/ATC) ready at this time to support uplinked 3-D flight plans. Rather, the 3-D flight plan must be stored manually. Storing the 3-D flight manually is additional pilot workload during the initial flight plan load, and during required en route flight plan updates as well.

The HITS technology suffers additional human factor issues as well, including poor off-path guidance, display clutter, cognitive tunneling, and pilot complacency. Pilots have reported that HITS may provide inadequate guidance when a pilot is flying off-path or outside the tunnel. When a pilot is off-path, the 3-D HITS tunnel may be out of view and distorted so that the pilot experiences difficulty in gauging a quality and degree of correction required to obtain or regain the flight path.

An increase in display clutter is another reported concern about the HITS tunnel symbology. Clutter on the HITS display is “masking clutter” whereby the tunnel occludes other display components, and it is also “perceptual clutter” in that the pilot experiences increased difficulty in detecting and interpreting the symbology of adjacent display components.

Two of the most safety critical issues facing the HITS technology and pilot performance are cognitive tunneling and complacency. Cognitive tunneling or “fixation” is a documented concern of the HITS technology. It has been reported that the “tunnel” symbology can become so compelling that it literally tunnels the pilots attention, whereby the pilot experiences increased difficulty in detecting unexpected events in both the near domain, e.g., airspeed, and the far domain, e.g., other aircraft that may be not be equipped with a transponder. However, even when a pilot does detect an unexpected event, such as identifying a potential intruder aircraft threat, the pilot does not always perform an appropriate response. Rather, the goal-post HITS symbology can promulgate display “loyalty” in that the vertical extensions of a goal post pathway are perceived as barriers that are not to be violated with a lateral avoidance maneuver, even in the face of oncoming traffic.

Currently, traffic collision avoidance information is provided to the pilot by a well-known Traffic Alert Collision Avoidance System (TCAS) on a navigation display separate from the head-down HITS display. FIG. 2 illustrates a conventional top-down display 20 used with a Traffic Alert Collision Avoidance System (TCAS) navigation display. In U.S. Pat. No. 6,433,729, entitled SYSTEM AND METHOD FOR DISPLAYING VERTICAL PROFILE OF INTRUDING TRAFFIC IN TWO DIMENSIONS, issued on Aug. 13, 2002, the complete disclosure of which is incorporated herein by reference, Thomas Staggs describes a conventional display 20 of the prior art used with a TCAS collision avoidance system. The conventional display 20 is a top-down display having an aircraft symbol 22 to depict the position of the protected host aircraft. A circle, formed by multiple dots 24 surrounding host aircraft position symbol 22, indicates an effective range from the host aircraft. Generally, semi circular indicia 26 around the periphery of indicator display 20 and a rotatable pointer 28 together provide an indication of the vertical altitude rate of change of the host aircraft. Indicia 26 are typically marked in hundreds of feet per minute.

Other target aircraft or “intruders” are identified on display 20 by indicia or “tags” 30, 32 and 34. Tags 30, 32, 34 are shaped as squares, circles or diamonds and are color coded (not shown) to provide additional information. Square 30 colored red represents an intruder entering warning zone and suggests an immediate threat to the host aircraft with prompt action being required to avoid the intruder. Circle 32 colored amber represents an intruder entering caution zone and suggests a moderate threat to the host aircraft recommending preparation for intruder avoidance. Diamond 34 represents near or “proximate traffic” when colored solid blue or white and represents more remote traffic or “other traffic” when represented as an open blue or white diamond. Air traffic represented by either solid or open diamond 34 is “on file” and being tracked by the TCAS.

Each indicia or tag 30, 32, 34 is accompanied by a two digit number preceded by a plus or minus sign. In the illustration of FIG. 2 for example, a “+05” is adjacent square tag 30, a “−03” is adjacent circle tag 32 and a “−12” is adjacent diamond tag 34. Each tag may also have an vertical arrow pointing either up or down relative to the display. The two digit number represents the relative altitude difference between the host aircraft and the intruder aircraft; the plus and minus signs indicating whether the intruder is above or below the host aircraft. Additionally, the two digit number appears positioned above or below the associated tag to provide a visual cue as to the intruder aircraft's relative position: the number positioned above the tag indicates that the intruder is above the host aircraft and the number positioned below the tag indicates that the intruder is below the host aircraft. The associated vertical arrow indicates the intruder aircraft's altitude is changing at a rate in excess of 500 feet per minute in the direction the arrow is pointing. The absence of an arrow indicates that the intruder is not changing altitude at a rate greater than 500 feet per minute.

Display 20 includes several areas represented by rectangular boxes 36, 38, 40, 42, 44 which are areas reserved for word text displays wherein conditions of the TCAS are reported to the pilot of the host aircraft. For example, if a portion or component of the TCAS fails, a concise textual report describing the failure appears in one of rectangular boxes 36, 38, 40, 42, 44. In another example, if the operator operates mode control 46 to select one of a limited number of operational modes, a concise textual message indicating the choice of operational mode appears in another of rectangular boxes 36, 38, 40, 42, 44. Selectable operational modes typically include a “standby” mode in which both of the host aircraft transponder systems are inactive, a “transponder on” mode in which a selected one of primary transponder and secondary transponder is active, a “traffic alert” mode in which an alert is transmitted to the protected host aircraft pilot if any Mode-C or Mode-S transponder equipped aircraft are entering a first predetermined cautionary envelope of airspace, and a “traffic alert/resolution advisory” mode in which a traffic alert (TA) and/or resolution advisory (RA) is issued if any Mode-C or Mode-S transponder equipped aircraft are entering a second predetermined warning envelope of airspace. The various operational modes described above are selectable by operating mode control 46.

The Vertical Speed Indicator (VSI) portion of indicator display 20, formed by the semi circular indicia 26 around the periphery and rotatable pointer 28, are used in the TCAS to indicate a rate of climb or descent that will maintain the safety of the host aircraft. In the particular example of FIG. 2, a colored arc portion 48, referenced by double cross-hatching, of the VSI scale indicates a recommended rate of climb intended to ensure the safety of the host aircraft. Another colored arc portion 50, referenced by single cross-hatching, of the VSI scale indicates a rate of descent which the TCAS recommends against for the host aircraft in the current situation. The operator of the intruder aircraft receives instructions coordinated with the host aircraft TCAS.

While TCAS represents one known system for predicting airborne collisions, other predictive systems are also known. For example, U.S. Pat. No. 5,325,302, entitled GPS-BASED ANTI-COLLISION WARNING SYSTEM, issued to Izidon, et al. on Jun. 28, 1994, the complete disclosure of which is incorporated herein by reference, describes a method for predicting a collision between two or more relatively moving aircraft, including determining a respective position in space for each one of the aircraft relative to a fixed frame of reference at a predetermined frequency to produce successive frames of positional data for each aircraft with a coupled memory for storing the successive positional data frames, computing a trajectory for each aircraft relative to the fixed frame of reference, and predicting whether two or more trajectories will intersect.

In U.S. Pat. No. 6,433,729, Staggs teaches a displaying showing a vertical profile view of situational awareness information. Staggs teaches reducing 3-dimensional traffic data into a 2-dimensional vertical profile view and displaying the situational awareness information in a 2-dimensional display. Conventional horizontal display symbology and processes are utilized, thereby maximizing commonality and avoiding costly retraining of flight crews to interpret data in a new fashion. Furthermore, the method and circuit taught by Staggs are applicable to TCAS or ACAS (Airborne Collision Avoidance System) and to all aerial traffic detection and collision avoidance systems.

The conventional top-down and 2-dimensional vertical profile views provided for TCAS and ACAS displays are provided on an independent cockpit display such as the display 30 illustrated in FIG. 2. During Instrument Flight Rules (IFR) flying, the separate display requires the pilot to divide attention between the two displays. As discussed above, the pilot may succumb to cognitive tunneling while using the HITS cockpit display, and may also succumb to complacency as surrounding traffic is invisible on the HITS head-down display illustrated in FIG. 1.

### SUMMARY OF THE INVENTION

Based on currently proposed concepts, HITS suffers from some unresolved documented human factors issues that include storing a 3-D flight plan, clutter, cognitive tunneling and complacency. Therefore, a system is still needed to improve the quality of information flow to the GA pilot. For example, the pilot's ability to perceive spatial relationships is critical to the safety of flight. Spatial flow is a graphical presentation technique that replicates the spatial motion and energy cues available in visual flying. During visual flight, pilots perceive movement and distance by combining evidence about texture, perspective, and color changes. Also, during visual flight, pilots often use landmarks, e.g., a mountain peak, on the horizon as a guide to a destination. These visual landmarks provide situation awareness. Furthermore, a traditional “T” instrument information configuration provides the pilot with instrument data that can be applied to improve situational awareness.

However, when flying in Instrument Meteorological Conditions (IMC), the spatial motion and energy cues and the landmarks are not available. Furthermore, the traditional “T” instrument information configuration provides only data, without information and context. The present invention overcomes these limitations of the prior art by providing an integrated head-down or head-up Primary Flight Display (PFD) presentation for tactical flight path management that changes flying Instrument Flight Rules (IFR) to be more like flying Visual Flight Rules (VFR). The integrated Primary Flight Display presentation of the present invention therefore replicates many of the spatial motion and energy cues basic to visual flight using spatial flow, integrates navigation information using substantially conformal symbology, and improves instrumentation using an enhanced “T” instrument display that goes beyond the traditional “T” instrument information configuration to provide the pilot with information and context along with the data.

The present invention overcomes the limitations of the prior art by providing a display control device having a processor that is coupled for receiving, at a known sampling rate, one or more different instrument data signals each of which reports information about a different flight parameter; and one or more algorithms resident on the processor and executable by the processor. The algorithms are structured to generate a plurality of display control signals as a function of the flight parameter information, the display control signals being structured to cause a display device to display one or more of: graphical depictions symbolic of one or more of a plurality of spatial motion and energy cues of a type available in conventional visual flying, navigation information as graphical depictions symbolic of one or more of a plurality of aerial and ground-based phenomena substantially conformally as a function of the navigation information, and a plurality of graphical depictions symbolic of the different instrument data, one or more of the plurality of graphical depictions being dynamically emphasized as a function of one of the different flight parameters.

According to one aspect of the invention, the algorithms resident on and executable by the processor are structured to generate display control signals that cause a display device to display the graphical depictions of at least one of the spatial motion and energy cues, at least one of the ground-based phenomena, and at least one of the different instrument data.

According to another aspect of the invention, the algorithms that are structured to generate display control signals that cause a display device to display the graphical depictions of the spatial motion and energy cues include one or more algorithms that are structured to generate display control signals that cause a display device to display a field of view (FOV) encompassing in the range of about 20-60 degrees in the horizontal and at least the conventional 2-3 degrees in the vertical and as much as 20-30 degrees, the FOV having a sky portion and a ground portion separated by a horizon representation and being superimposed with one or more of texture, perspective, and color features.

According to another aspect of the invention, the algorithms that are structured to generate display control signals that cause a display device to display the graphical depictions of the spatial motion and energy cues also include one or more algorithms that are structured to generate display control signals that cause a display device to display graduated color features superimposed on one or both of the sky portion and the ground portion of the FOV.

According to another aspect of the invention, the one or more algorithms that are structured to generate display control signals that cause a display device to display the graphical depictions of the spatial motion and energy cues include one or more algorithms that are structured to generate display control signals that cause a display device to display perspective lines superimposed on the ground portion of the FOV.

According to another aspect of the invention, the one or more algorithms that are structured to generate display control signals that cause a display device to display the graphical depictions of the spatial motion and energy cues include one or more algorithms that are structured to generate display control signals that cause a display device to display one or more texture cues on the ground portion of the FOV.

According to another aspect of the invention, the one or more algorithms that are structured to generate display control signals that cause a display device to display the graphical depictions of the substantially conformal ground-based phenomena further include one or more algorithms that are structured to generate display control signals that cause a display device to display one or more of a substantially conformal runway/airport symbol, a substantially conformal lateral deviation indicator symbol in combination with a substantially conformal lateral path indication symbol, a substantially conformal lateral current waypoint symbol, a substantially conformal next waypoint symbol, and substantially conformal intruder aircraft and collision avoidance symbology. The substantially conformal intruder aircraft and collision avoidance symbology includes intruder aircraft and collision avoidance information supplied by an onboard TCAS (Traffic Alert Collision Avoidance System) or ACAS (Airborne Collision Avoidance System) or another aerial traffic detection and collision avoidance system.

According to another aspect of the invention, the one or more algorithms that are structured to generate display control signals that cause a display device to display the graphical depictions of the instrument data also include one or more algorithms that are structured to generate display control signals that cause a display device to display one or more of an indicated air speed, an attitude, an altitude, a heading, a pictographic mode of flight indicator, and a simulated visual glideslope. Additionally, one or more algorithms are included that are structured to generate display control signals that cause a display device to display one of the graphical depictions of the instrument data as a dynamically emphasized graphical depiction as a function of one of a mode and a phase of flight. One or more algorithms are included that are structured to generate display control signals that cause a display device to display the dynamically emphasized graphical depiction of instrument data as having a visual appearance different from a nominal visual appearance.

According to other aspects of the invention, computer program products are provided for receiving the one or more different instrument data signals and generating the plurality of display control signals, as described herein.

According to yet other aspect of the invention, the invention provides methods for receiving the one or more different instrument data signals and generating the plurality of display control signals, as described herein.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is one embodiment of NASA-sponsored “Highway in the Sky” (HITS) display format which is intended to improve the safety and ease of GA flying;

FIG. 2 illustrates a conventional top-down display commonly used with a known Traffic Alert Collision Avoidance System (TCAS) navigation display;

FIG. 3 illustrates by example and without limitation the integrated display presentation of the present invention embodied as an integrated cockpit display;

FIG. 4A by example and without limitation conformal lateral path and lateral path deviation cues of the invention viewed on approach at a first further distance from a runway;

FIG. 4B by example and without limitation the conformal lateral path and lateral path deviation cues of FIG. 4A viewed on approach at a second closer distance from a runway;

FIG. 4C by example and without limitation conventional lateral path and lateral path deviation cues presented on the integrated display presentation of the invention viewed on approach to a runway; and

FIG. 5 illustrates by example and without limitation the integrated display presentation system of the invention embodied as a system block diagram for tactical flight path management in an aircraft environment.

### DETAILED DESCRIPTION OF PREFERRED EMBODIMENT

In the Figures, like numerals indicate like elements.

The present invention is an apparatus and method for an integrated display presentation for tactical flight path management that simplifies instrument flight and makes it more like visual flight by replicating many of the cues basic to visual flight by integrating visual cues using spatial flow, integrating navigation information using conformal symbology, and improving instrumentation using an enhanced “T” instrument display.

Briefly, spatial flow is a graphical presentation technique that replicates one or more of the spatial motion and energy cues available in visual flying. Conformal symbology integrates navigation information using pre-attentive referencing by constructing visual depictions symbolic of ground-based phenomena, waypoints and other data as to conform to a view from the aircraft's cockpit. Conformal symbology optionally includes intruder aircraft and collision avoidance information supplied by a TCAS (Traffic Alert Collision Avoidance System) or ACAS (Airborne Collision Avoidance System) or another aerial traffic detection and collision avoidance system. Conformal symbology is rendered either using true one-to-one mapping, or using conformal compressed symbology in which the information is rendered using mapping that is not a true one-to-one mapping whereby the information on the display is maximized.

The enhanced “T” instrument display replicates and improves the instruments that are found in the pilot's basic “T” configuration provided by conventional displays. The basic data parameters available in the standard electromechanical “T” configuration include: airspeed, attitude, altitude, turn coordination, heading, and vertical speed. The enhanced “T” instrument display of the invention provides these and other previously demonstrated symbology elements developed for jet cockpits that are now affordable for GA, e.g., a pitch limit indicator, and supplemented with new concepts developed specifically for the GA marketplace, e.g., Virtual VASI which is described in detail herein and in co-pending U.S. patent application Ser. No. 10/052,716, entitled SIMULATED VISUAL GLIDESLOPE INDICATOR ON AIRCRAFT DISPLAY, which is incorporated by reference herein.

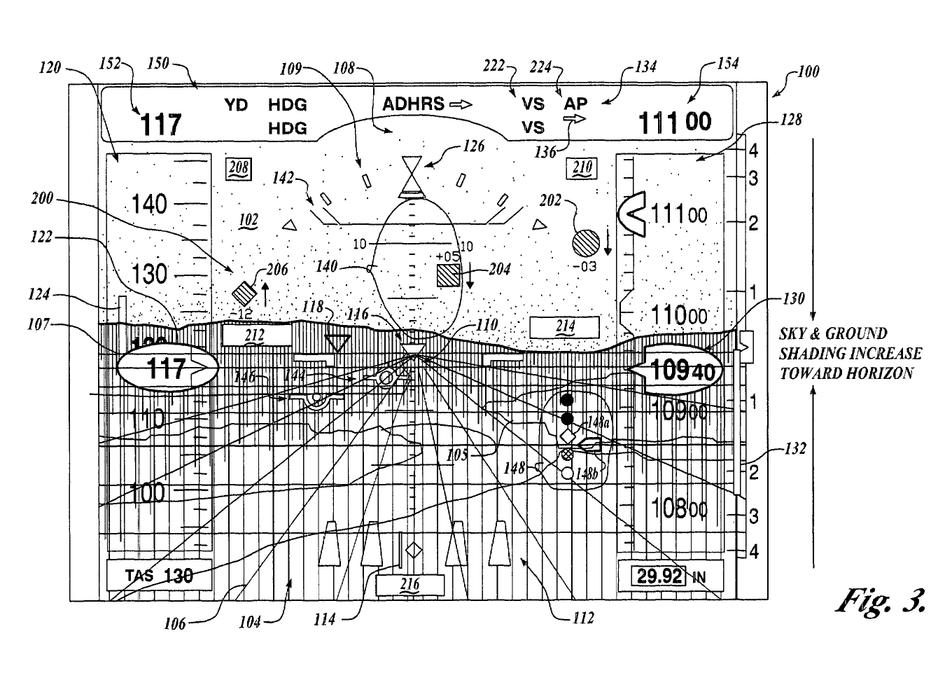

FIG. 3 illustrates by example and without limitation the integrated display presentation of the present invention embodied as an integrated cockpit display 100. The invention embodied as the integrated display 100 addresses the safety issues raised by the human factor limitations of the HITS technology, as discussed above, that include a requirement of storing a 3-D flight plan, clutter, cognitive tunneling and complacency. The integrated display presentation of the present invention embodied as the integrated display 100 addresses these safety issues by providing a seamless interface from take-off through landing that is independent of a stored 3-D flight plan, which is a known limitation of the HITS technology. The cues provided by the integrated display presentation of the invention provide consistent lateral and vertical guidance, regardless of distance from the desired flight path. A pilot is thereby ensured to have consistent flight path guidance, even when the pilot is significantly off path, which is when path guidance is most required.

FIG. 3 illustrates the integrated display presentation of the invention embodied as the cockpit display 100 that replicates many of the cues basic to visual flight using spatial flow, conformal symbology, and enhanced “T” instrument display. The cockpit display 100 is by example and without limitation a graphical cockpit display embodied, for example, as a Primary Flight Display (PFD) 100. A suitable head-down PFD is the Honeywell DU-1080 Display Unit, which is a color active matrix liquid crystal display based device 10.4″ diagonal in size which is available from Honeywell International, Inc. of Morristown, N.J. Alternatively, the integrated display presentation for tactical flight path management of the invention is displayed on a Head-Up Display (HUD), which is, for example, the HUD2020 also available from Honeywell International, Inc. Many other displays are also suitable for practicing the integrated display and integrated display presentation of the invention; the Honeywell DU-1080 Display Unit and HU2020 unit being only examples used to demonstrate the invention and not intended in any way to limit the scope of the invention. As discussed and illustrated herein the integrated display presentation of the invention is not limited to the integrated display embodiment illustrated in FIG. 3, but is alternatively embodied in one or more alternative cockpit displays that also replicate cues basic to visual flight using spatial flow, conformal symbology, and enhanced “T” instrumentation display technology of the invention.

Spatial Flow

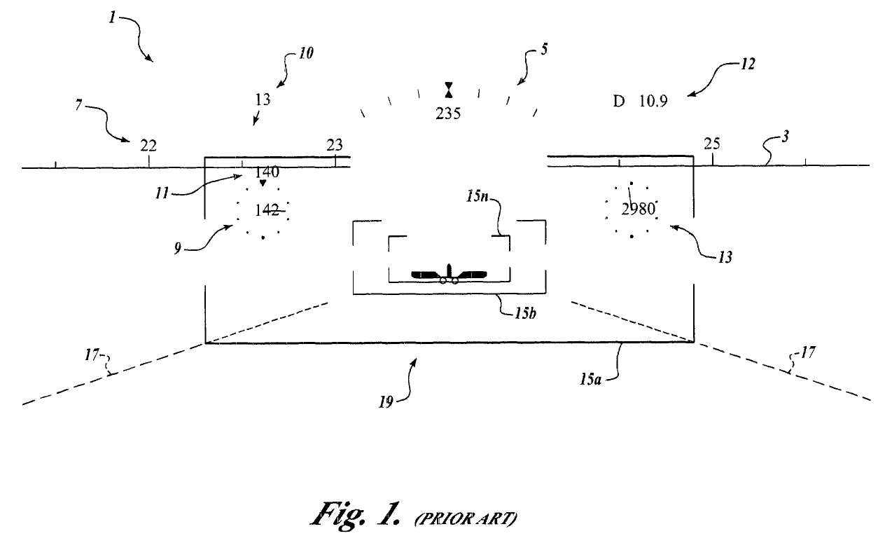

An ability of the pilot to perceive spatial relationships is understood to be critical to the safety of flight. Spatial flow is a graphical presentation technique that replicates the spatial motion and energy cues available in visual flying. During visual flight, pilots perceive movement and distance by combining evidence about texture, perspective, and color changes. These same immergent features: texture, perspective, and color, are recreated and integrated in the cockpit display 100 by the integrated display presentation of the invention being operated by onboard automation. The spatial flow symbology elements provided on the cockpit display 100 by the integrated display presentation of the invention include an expanded vertical and horizontal field of view (FOV) relative to the narrow horizontal and vertical field of view presented by the HITS technology as shown in FIG. 1. The spatial flow symbology elements provided by the integrated display presentation of the invention also include color shading of sky 102 portion of the display 100 in shades of blue (color not shown) and the ground 104 portion in shades of brown or green or both (color not shown), as well as one or more optional random terrain texturing cues 105 superimposed on top of the colored ground. Horizontal and longitudinal perspective line segments 106 are superimposed on the ground portion 104. A top one of the horizontal line segments 106 is symbolic of a horizon 107 that separates the sky and ground portions 102, 104. Color gradations displayed in the sky portion 102 (illustrated as shading increasing toward the ground portion 104) replicate color gradations in the sky on a clear blue day and thereby facilitate pre-attentive processing for depth perception, as well as indications for unusual attitude recovery. Perspective lines 106 on the ground portion 104 and color shading that increases toward the horizon 107 assist depth perception.

The integrated picture of cues of texture, perspective, and color provided by the integrated display presentation of the invention on the cockpit display 100 reproduce “optical flow,” which can be defined as momentary velocity of one or more of texture and grid lines across the visual field that the pilot perceives close to the ground. Optical flow is achieved by regularly sampling the navigation data signals and using the updated information to update the positions of the terrain cues 105 and perspective lines 106 on the display presentation. The terrain cues 105 and perspective lines 106 are thus moved over the display screen at a rate that simulates the aircraft's changing position with respect to the ground. The relative positions of the terrain cues 105 and perspective lines 106 can be updated as a function of either the airspeed or position information. The optical flow thus reproduced by the invention on the display 100 improves situational awareness (SA), which can be defined as perception of elements in the environment within a volume of time and space and the projection of their status in the near future. The pilot is thereby better able to form a mental model of the current and projected states of the external flight environment.

A peripheral field is reported to be superior to central vision for the mediation of self motion or “vection. ” The expanded field of view provided by the “spatial flow” technology of the invention as operated by the onboard automation and presented on the display 100 thus provides valuable peripheral motion feedback which permits periphery detection, and thereby assists pilot performance and reaction time to an attitude upset. The peripheral field provided by the invention's expanded vertical and horizontal FOV is therefore superior to the more limited central vision of the HITS technology, which may remove meaningful motion cues, such as intruding aircraft, from the pilot's peripheral view. The expanded vertical and horizontal FOV provided on the display 100 is, however, limited to avoid becoming too distracting or creating a scan area too large to be comfortably viewed. Accordingly, based upon pilot feedback an appropriate expanded FOV is about 20 or 25 to about 45 or as much as about 60 degrees in the horizontal by 15 to 20 or 30 degrees in the vertical. The vertical FOV is optionally about one half the angle of the horizontal FOV. For example, according to one embodiment of the invention, the information is rendered on the display 100 using true one-to-one mapping whereby the FOV about 25 degrees or +/−12.5 degrees in the lateral and 13 degrees or +/−6.5 degrees in the vertical. According to another embodiment of the invention, the information is rendered on the display 100 using compressed mapping whereby the FOV about 45 degrees or +/−22.5 degrees in the lateral and 24 degrees or +/−12 degrees in the vertical.

The upper vertical portion of the generally rectangular FOV includes an arcuate or curved portion 108 that outlines and highlights the conventional roll scale 109 and generates a “keyhole” effect for the display 100.

Conformal Symbology

Outside relationships are replicated on the head-down or head-up flight display 100 inside the aircraft via conformal symbology, whereby navigation information is integrated and positioned on the display 100 to appear in positions consistent with a view as seen on from the cockpit. Conformal symbology is rendered either using true one-to-one mapping, or using conformal compressed symbology as discussed herein. The invention thereby presents visual cues in a “real world” context while flying IFR on a PFD, similar to that experienced flying VFR. Presentation of conformal symbology on the cockpit display 100 has led to demonstrated improvement in overall SA. Conformal symbology permits the pilot to utilize pre-attentive referencing, which is a recognition driven process that reduces pilot workload, rather than requiring conscious decision. Tracking performance has been shown to improve when conformal symbology is used to present navigation information.

According to the present invention, conformal symbology elements include without limitation: a conventional runway/airport symbol 110, lateral path and deviation indicator symbols 112, 114, and conventional lateral current and next waypoint symbols 116, 118. The conformal symbology of the present invention as embodied in the integrated display 100 reduces pilot workload, particularly close to the ground, by removing ambiguity of objects in the far domain, i.e., the external world, that exist in instrument conditions by presenting those objects in the near domain, i.e., the display 100, in positions consistent with a view as seen on from the cockpit. The conformal display symbology of the invention further aids pilots in the transition from near domain to far domain by presenting the information using symbology that mimics the form of the objects as they appear in the far domain. For example the virtual rising runway symbol 110 illustrates by example and without limitation the conformal display symbology of the invention presented on the cockpit display 100.

Enhanced “T”

The enhanced “T” replicates and improves the instruments that are found in the pilot's basic “T” provided in conventional displays. The basic data parameters available in the standard electromechanical “T” configuration include: airspeed, attitude, altitude, turn coordinator, heading, and vertical speed. These data are presented in the basic “T” configuration using conventional analog needle displays and digital readouts. A traditional “T” configuration thus provides the pilot with data.

The enhanced “T” configuration of the present invention also provides the airspeed, attitude, altitude, turn coordinator, heading, and vertical speed data. The enhanced “T” configuration includes by example and without limitation an indicated air speed indicator 120 configured as a scale or tape having a pointer 122 showing the current indicated air speed and an airspeed trend indicator 124; a conventional ball/attitude indicator 126; and an altitude indicator 128 configured as a scale or tape and having a pointer 130 showing the current aircraft altitude, and an altitude trend indicator 132. A conventional heading pointer on a compass rose (not shown) may be provided and may be supplemented by a digital readout of heading angle. A vertical speed trend indicator may be provided by an optional pictographic information display 134 using an arrow or other pointer mechanism 136. The pictographic information display 134 may also display true air speed as well as additional information about the operational mode of the aircraft. The pictographic information display 134 is a new element provided on the display 100 and is described more completely in co-pending patent application Ser. No. ______ (Attorney Docket Number H0001712), entitled PICTOGRAPHIC MODE AWARENESS DISPLAY FOR AIRCRAFT, which is incorporated herein by reference.

The enhanced “T” configuration of the present invention replicates and improves the traditional “T” configuration by providing the pilot with information and “real world” context, modeling some display elements after those in modern commercial jet aircraft. FIG. 3 also illustrates without limitation examples of the enhanced “T” technology that enhance the traditional “T” configuration. One example of the enhanced “T” illustrated in FIG. 3 is a conformal pitch limit indicator (PLI) 138 embodied as a graphic indicator of the point of stall warning for the aircraft on a pitch scale 140 or a conventional pitch reference 142. The display may include a conventional flight path vector 144 and flight path vector director 146. Another new element presented on the display 100 is a simulation of an airport lighting aid configured as a simulated visual glideslope information display 148 on the cockpit display. The simulated visual glideslope information display 148, which takes the form of a Precision Approach Path Indicator (PAPI) or Visual Approach Slope Indicator (VASI), is described more completely in co-pending U.S. patent application Ser. No. 10/052,716, entitled SIMULATED VISUAL GLIDESLOPE INDICATOR ON AIRCRAFT DISPLAY, which is incorporated herein by reference.

The basic principle of the simulated visual glideslope is that of monochromatic scaling. By example and without limitation, four indicators are arranged so that the pilot using the simulated visual glideslope during an approach sees the combination of indicators shown in FIG. 3. Depending on descent angle, the indicators appear either black or white. If the aircraft glideslope is too low all the indicators appear black, if it is too high, all indicators appear white. The indicators appear in shades of gray when slightly off an ideal approach path. When correctly on path, the top indicators appear black and the bottom indicators appear white.

Alternatively, the simulated visual glideslope information display 148 is implemented using red and white indicators with scaling in one or more shades of pink when slightly off an ideal approach path. When correctly on path, the top indicators appear red while the bottom indicators appear white.

The simulated visual glideslope path information display 148 also provides between the upper and lower pairs of indicators an ideal glideslope target 148a shown by example and without limitation as a white or other colored diamond indicator. The simulated visual glideslope information display 148 thus provides a qualitative indication of the aircraft's deviation above or below the ideal glideslope. The simulated visual glideslope information display 148 also enhanced by a vertical deviation indicator bar 148b, that is programmed to simulate a traditional vertical deviation scale, and thereby provide additional information as to the degree of deviation. The indicator bar 148b of the simulated visual glideslope information display 148 thus indicates to the pilot the amount and direction of change in altitude, either higher or lower, to increase the degree of coincidence with the glideslope. The simulated visual glideslope information display 148 thus provides the perceptual airport lighting aid information and leverages the advanced display 100 to integrate the cue with the vertical deviation bar.

In FIG. 3 the column of indicators and the vertical deviation indicator bar 148b of the simulated visual glideslope information display 148 indicate the aircraft is slightly below ideal glideslope. The top indicators appear dark and the bottom indicators appears white, but the upper bottom indicator is shaded, i.e., scaled between the white and the dark color of the upper indicators. Also, the vertical deviation indicator bar 148b is below the ideal glideslope target 148a.

According to the invention as illustrated in FIG. 3, the enhanced “T” technology of the invention also provides on the display 100 another display portion 150 at the top of the screen or in another convenient location. The display portion 150 includes by example and without limitation the pictographic display 134 as well as an air speed readout 152, an altitude readout 154, and other information.

The enhanced “T” technology of the invention is also provided as a dynamic display presentation whereby one or more of the different information displays, including for example and without limitation the information displays of airspeed 120, air speed readout 152, attitude, altitude 126, altitude readout 154, heading, and vertical speed, are dynamically presented in a context sensitive manner. One or more of the pictographic display 134 and the airport lighting aid simulation display 148 may be displayed dynamically as well.

According to the enhanced “T” portion of the invention, the dynamic presentation of the instrument displays is context sensitive, whereby different ones of the information displays are dynamically emphasized as a predetermined function of the current mode or phase of flight. The emphasis is provided to draw the pilot's attention to the information particularly relevant to the current phase of flight, e.g., taxi, take off, cruising, approach, landing and ground phases of flight or the current mode of flight, e.g., vertical speed (VS), indicated air speed (IAS), flight path angle (FPA), vertical navigation (VNAV), altitude hold (ALT), flight level change (FLCH) modes of flight, as well as the numerous other control parameters involving air craft attitude, speed, and thrust settings. Accordingly, a predetermined one or more of the different information displays is dynamically emphasized as a function of mode or phase of flight, with different ones of the information displays being emphasized during different modes or phases of flight. At about the time each different mode or phase of flight is entered, one or more of the information displays relevant to the respective mode or phase of flight is caused by the invention to metamorphose, i.e., the information displays strikingly transform its appearance, so as to draw the pilot's attention to an instrument reporting a flight parameter that is important or even critical during the current mode or phase of flight.

For example, the vertical speed area of the pictographic display 134 is dynamically emphasized while the aircraft is operating in the vertical speed (VS) mode as is a vertical speed indicator, if available. In another example, the altitude (ALT) information display area 128 is emphasized during an altitude mode of operation, such as closing on minimum descent altitude or minimum descent height (MDH) or off altitude operation.

The dynamic operation of the different information displays is of a predetermined character. For example, the different information displays are emphasized by metamorphosis or transformation in appearance using any of an animated size, font, shading and texture. The animated size emphasis is produced by increasing the size of the information display on the display 100 by an amount that will bring it to the pilot's attention, by example and without limitation a 20 percent size increase is used. For example, the altitude indicator 128 is increased in size on the display 100 by 20 percent during an altitude mode of operation, such as off altitude operation. The animated font emphasis is produced by increasing the font size in the indicator area by an amount that will bring it to the pilot's attention, by example and without limitation a 20 percent size increase is used. Additionally, the font color is optionally changed from a neutral color to amber, as a warning indication, or red, as a critical warning indication, as permitted by the FAA.

The animated shade emphasis is also produced by increasing the shade or color of the information display on the display 100 by an amount that will bring it to the pilot's attention. By example and without limitation a color change from white to yellow or red is used. For example, the color of the vertical speed area in the pictograph 134 is shaded from a neutral color such as green or white to yellow on the display 100 when the aircraft is operating in a vertical speed (VS) mode of flight. Additionally, the emphasis is optionally produced using texture metamorphosis or transformation, whereby the texture of an information display is emphasized by changing texture of the information display on the display 100. For example, the texture of an information display is elevated from dashed or dotted to solid line during either of a mode or phase of flight during which that particular information display is critical.

The invention is further operated to emphasize on the display 100 different ones of the information displays as a function of cautionary or critical situations in a manner that will bring it to the pilot's attention using, by example and without limitation, a change in color from a neutral color to a cautionary or danger color. For example, the vertical speed area of the pictographic information display 134 providing vertical speed (VS) information is emphasized during an over speed or low speed condition by shading the color from a neutral green or white to a cautionary yellow or a danger red. In another example, the flight path angle (FPA) area of the pictographic information display 134 is emphasized during an off path situation on approach by shading the color from a neutral green or white to yellow or red. In yet another example, disturbance to intended attitude and path permits a pilot to detect windshear early so that an unrecoverable condition is less likely to occur. Thus, when disturbance to one or both the intended attitude and path is detected, one or both of the attitude indicator 126 and flight path angle (FPA) area of the pictographic information display 134 are metamorphosed or transformed dynamically to draw the pilot's attention. The dynamic metamorphosis of the one or more information displays on the display 100 is provided by an emphasis of one or more of display size, font, color and texture. Flight safety is thus improved.

In yet another example, an information display is emphasized by its sudden appearance on the display 100. For example and without limitation, the simulated airport lighting aid 148 is absent from the display 100 during normal operation of the aircraft, only appearing during approach. The dynamic metamorphosis of the one or more information displays on the display 100 is provided by an appearance on the display 100 during an appropriate mode or phase of flight.

Among the outside relationships replicated on the PFD 100 inside the aircraft via the conformal symbology aspect of the invention, TCAS or ACAS (Airborne Collision Avoidance System) and to all aerial traffic detection and collision avoidance system information, such as Traffic Alert Collision Avoidance System (TCAS) or Airborne Collision Avoidance System (ACAS) navigation information, is integrated and positioned on the display 100 to appear in positions consistent with a view as seen on from the cockpit. The invention thereby presents visual aerial traffic cues in a “real world” context while flying IFR on a head-down or head-up display, similar to that experienced flying VFR. Accordingly, FIG. 3 also illustrates by example and without limitation an optional conformal TCAS or ACAS navigation display which may be provided in a wide-angle look-ahead view in contrast to the top-down view provided in conventional TCAS displays.

As described by U.S. Pat. No. 4,855,748, which is incorporated herein by reference, TCAS is a direction finding antenna system for determining the relative bearing of an intruding aircraft from a protected aircraft. TCAS equipment located aboard a protected aircraft periodically transmits interrogation signals that are received by reporting transponders located aboard intruding aircraft in the vicinity of the protected aircraft. The transponder of the intruding aircraft transmits a signal which reports its altitude. The TCAS equipment computes the range of the intruding aircraft by using the round-trip time between the transmission of the interrogation and the receipt of the reply. The TCAS equipment may also provide relative bearing information.

Altitude, altitude rate, range and range rate, and relative bearing are determined by tracking the reply information. These data, together with the current TCAS sensitivity level, which specifies the protected volume around the aircraft, are used to determine whether the intruding aircraft is a threat. Each threat aircraft is processed individually to permit selection of the minimum safe resolution advisory based on track data and coordination with other TCAS-equipped aircraft.

FIG. 3 illustrates the wide-angle look-ahead conformal view of TCAS information provided by the integrated display 100 of the invention. According to the present invention, the integrated display 100 of the invention is coupled to receive the TCAS information and is structured to isolate that portion of the information that lies within the scope of the illustration of the real world provided on the display 100. In other words, the invention determines that portion or “slice” of the TCAS information relevant to the wedge shaped field of view (FOV) encompassed by the integrated display 100 of the invention. The invention isolates this relevant portion of the TCAS information and operates as a repeater to displays it to the pilot. Thus, any intruding aircraft approaching the protected host aircraft within the range of the onboard TCAS equipment is detected by the TCAS equipment. The integrated display 100 of the invention receives the information and determines which, if any, of the intruding aircraft are within the horizontal and vertical FOV presented by the integrated display 100 of the invention. The invention reduces the 3-dimensional traffic data into a 2-dimensional wide-angle look-ahead view and presents the information conformally superimposed with the sky and ground portions 102, 104. Thus, the intruder aircraft appear on the display 100 at approximately the same positions relative to the aircraft as they would appear, if visible, through the cockpit windscreen.

Conventional horizontal display symbology and processes are utilized to depict the intruding aircraft, thereby maximizing commonality and avoiding costly retraining of flight crews to interpret data in a new fashion. Furthermore, the method and circuit of the invention are applicable to TCAS or ACAS (Airborne Collision Avoidance System) and to all aerial traffic detection and collision avoidance systems.

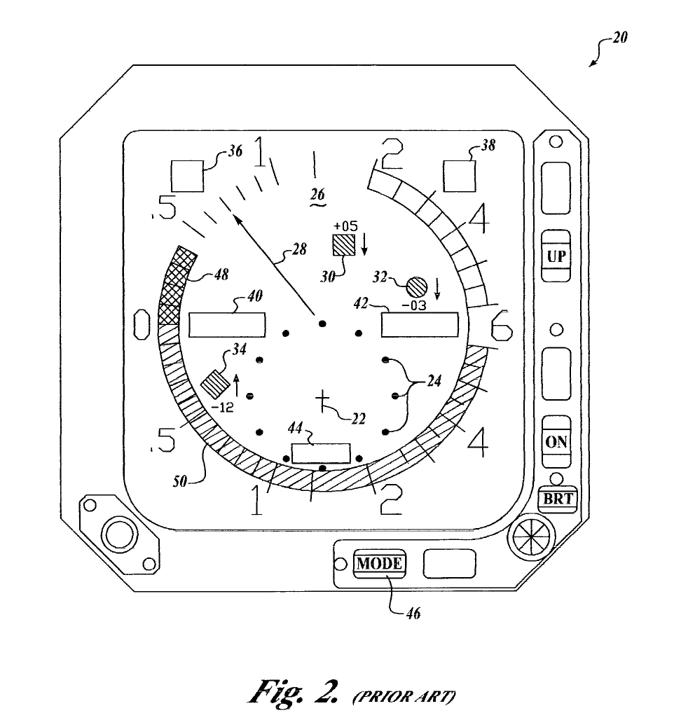

An assumption of the traditional horizontal or top-down representation (shown in FIG. 2) is that many aircraft are being flown in level horizontal planes. However, the probability of an intruding aircraft being exactly on a given horizontal plane is quite small. Therefore, the integrated display 100 of the invention incorporates into the look-ahead representation 200 of TCAS data a vertical element of the 3-dimensional traffic data. Thus, the 3-dimensional sampling volume traffic data is depicted as compressed into a vertical plane as seen through the cockpit windscreen. Any intruder aircraft lying within the 3-dimensional sampling volume of the onboard TCAS equipment and within the FOV of the protected host aircraft represented by the integrated display 100 of the invention are represented as lying within that planar FOV, as shown by intruder aircraft tags circle 202, square 204, and diamond 206. Other intruder aircraft lying within the 3-dimensional sampling volume but outside the particular FOV represented by the integrated display 100 are not represented.

Preferably, commonality with current TCAS systems is maximized, thereby avoiding retraining of flight crews to learn to interpret data in a new fashion. Other symbology is similarly contemplated, and although perhaps not as familiar to the flight crew trained to use conventional horizontal profile displays, are considered to be within the scope of the invention. Therefore, the invention preferably uses current TCAS symbology to represent an intruder. Accordingly, similar to circle 32 (shown in FIG. 2), circle 202 colored amber represents an intruder entering the alert zone and suggests a moderate threat to the protected host aircraft recommending preparation for intruder avoidance. Similar to square 30 (shown in FIG. 2), square 204 colored red represents an intruder entering warning zone and suggests an immediate threat to the host aircraft with prompt action being required to avoid the intruder. Diamond 206, similar to diamond 34 (shown in FIG. 2) represents near or “proximate traffic” when colored solid blue or white and represents more remote traffic or “other traffic” when represented as an open blue or white diamond. Air traffic represented by either solid or open diamond 206 is “on file” and being tracked by the TCAS similar to diamond 34.

Similar to the description in FIG. 2, each indicia or tag 202, 204, 206 is accompanied by a two digit number preceded by a plus or minus sign. In the illustration of FIG. 3 for example, a “+05” is adjacent square tag 204, a “−03” is adjacent circle tag 202 and a “−12” is adjacent diamond tag 206. Each tag may also have an vertical arrow pointing either up or down relative to the display. The two digit number represents the relative altitude difference between the host aircraft and the intruder aircraft; the plus and minus signs indicating whether the intruder is above or below the host aircraft. Additionally, the two digit number appears positioned above or below the associated tag to provide a visual cue as to the intruder aircraft's relative position: the number positioned above the tag indicates that the intruder is above the host aircraft and the number positioned below the tag indicates that the intruder is below the host aircraft. The associated vertical arrow indicates the intruder aircraft's altitude is changing at a rate in excess of 500 feet per minute in the direction the arrow is pointing. The absence of an arrow indicates that the intruder is not changing altitude at a rate greater than 500 feet per minute.

Depiction of Potentially Corrective Action

If the treat detection logic in the TCAS computer determines that a proximate aircraft represents a potential collision or near-miss encounter, the computer threat resolution logic determines the appropriate vertical dive or climb maneuver that will ensure the safe separation of the TCAS aircraft. The appropriate maneuver is one that ensure adequate vertical separation while causing the least deviation of the TCAS aircraft from its current vertical rate.

As discussed above, the TCAS described in the RTCA/DO-185 document provides advisories only for vertical maneuvers of the protected aircraft to escape collision with a threat aircraft. U.S. Pat. No. 4,855,748 provides an improved TCAS that provides advisories for horizontal right or left turn maneuvers as well as for vertical maneuvers, thereby further reducing the probability of collision. When the protected host aircraft is provided with the improved four-antenna TCAS system as taught by U.S. Pat. No. 4,855,748, the TCAS equipment provides and utilizes knowledge of the relative bearing of the intruding aircraft from the protected aircraft, in addition to the other data normally collected by standard TCAS equipment, to provide advisories for horizontal right or left turn maneuvers as well as for vertical maneuvers.

The integrated display 100 of the invention may also include one or more areas represented by rectangular boxes 208, 210, 212, 214, 216 which are areas reserved for word text displays wherein conditions of the TCAS are reported to the pilot of the host aircraft. For example, if a portion or component of the TCAS fails, a concise textual report describing the failure appears in one of rectangular boxes 208, 210, 212, 214, 216. In another example, if the operator operates the mode control 46 of the TCAS (shown in FIG. 2) to select one of a limited number of operational modes, a concise textual message indicating the choice of operational mode appears in another of rectangular boxes 208, 210, 212, 214, 216. The selectable operational modes are described above and typically include a “standby” mode in which both of the host aircraft transponder systems are inactive, a “transponder on” mode in which a selected one of primary transponder and secondary transponder is active, a “traffic alert” mode in which an alert is transmitted to the protected host aircraft pilot if any Mode-C or Mode-S transponder equipped aircraft are entering a first predetermined cautionary envelope of airspace, and a “traffic alert/resolution advisory” mode in which a traffic alert (TA) and/or resolution advisory (RA) is issued if any Mode-C or Mode-S transponder equipped aircraft are entering a second predetermined warning envelope of airspace.

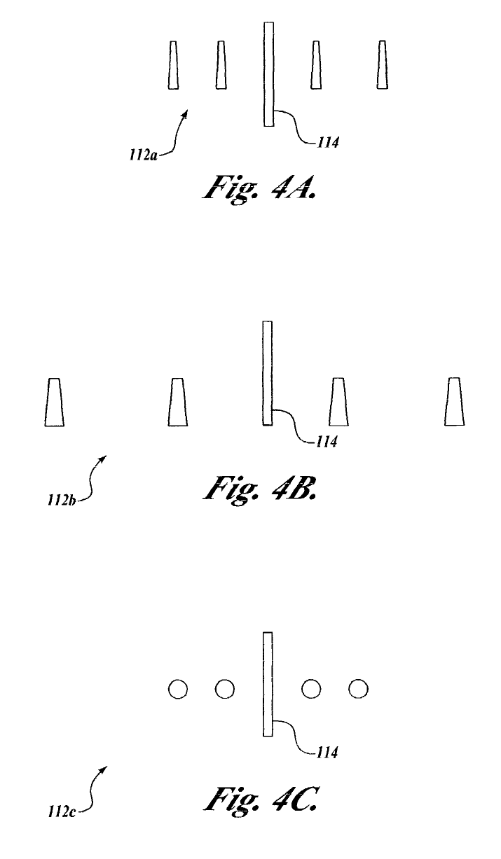

FIGS. 4A and 4B illustrate by example and without limitation a course deviation indicator utilizing the conformal lateral deviation indicator cues 112 of the invention and the conformal lateral path indication cues 114 of the invention on approach. The Figures illustrate the invention at different first further (cues 112a of FIG. 4A) and second closer (cues 112b of FIG. 4B) distances from the ground. One embodiment of the invention uses two deviation marks located on each side of the runway centerline. During an ILS (Instrument Landing System) approach each mark represents 1.75 degrees lateral separation. Full scale sensitivity of the course deviation indicator is 5 degrees or 2.5 deg each side. On a VOR approach (a VHF Omnidirectional Radio Range ground-based navigation device that provides bearing information to an aircraft) each mark represents 5 degrees lateral separation for a full scale of 10 degrees each side and a total radial span of 20 degrees.

As illustrated in FIGS. 4A and 4B, the conformal lateral deviation indicator cues 112 increase in apparent size and spread apart as the host aircraft approaches the ground more closely. The lateral deviation marks provide a scale for determining the lateral deviation from the course or centerline. The deviation marks also convey intuitive altitude information. At high altitudes the deviation marks are displayed close together. As altitude decreases, the deviation marks spread apart, just as if they were actually drawn on the earth. The conformal lateral deviation indicator cues 112 of the invention thus mimic lateral deviation cues on the target runway, if such were visible. The lateral deviation marks thereby provide an intuitive display to communicate three dimensional situational data to a pilot, simplify aircraft navigation, reduce pilot workload and increase aircraft safety.

The means of forming the conformal lateral deviation indicator cues 112 are generally well-known and are described by Uhlenhop and Wilkens in U.S. Pat. No. 5,745,863, entitled THREE DIMENSIONAL LATERAL DISPLACEMENT DISPLAY SYMBOLOGY WHICH IS CONFORMAL TO THE EARTH, issued on Apr. 28, 1998, which is owned by the assignee of the present application and the entirety of which is incorporated herein by reference. The conformal lateral path indication cues 114 of the invention are formed using similar means.

U.S. Pat. No. 5,745,863 discloses an aircraft display which communicates three dimensional lateral information to a pilot of the aircraft. An extended course centerline symbol and lateral deviation marks indicate lateral deviation from a desired course along with approximate altitude and distance-to-go information to the pilot. The course centerline extends toward a vanishing point near the horizon line, as illustrated in FIG. 3. The centerline symbol swings laterally across the display responsive to changes in lateral deviation of the aircraft such that an intuitive perspective view is provided to the pilot. Lateral deviation marks similar to those shown in FIGS. 3, 4A and 4B provide precise lateral deviation information to the pilot.

U.S. Pat. No. 5,745,863 discloses using available navigation data to compute and then display a course centerline which extends toward a vanishing point near the horizon line of the display. The centerline symbol simulates a course centerline drawn on the earth's surface, hence the term “conformal.” According to the present invention, the conformal lateral path indication cue 114 is also displayed in a perspective view, thereby providing a conformal centerline.

During the approach phase of flight the present invention provides the conformal lateral path indication cue 114 along the approach path. At high altitudes large lateral movement of the aircraft is required to move the position of the conformal lateral path indication cue 114, while at low altitudes much smaller lateral movement of the aircraft is required to make an equivalent move of the conformal lateral path indication cue 114.

U.S. Pat. No. 5,745,863 discloses simulating the earth surface as a flat surface 2000 feet below cruise altitude. During approach the earth surface is thus simulated as a flat surface at the same altitude as the destination runway.

FIG. 4C illustrates by example and without limitation conventional lateral deviation indicator cues 112c utilized with conventional flight displays. The conventional lateral deviation indicator cues 112c are optionally substituted in the presentation of the invention for the conformal lateral deviation indicator cues 112 of the invention.

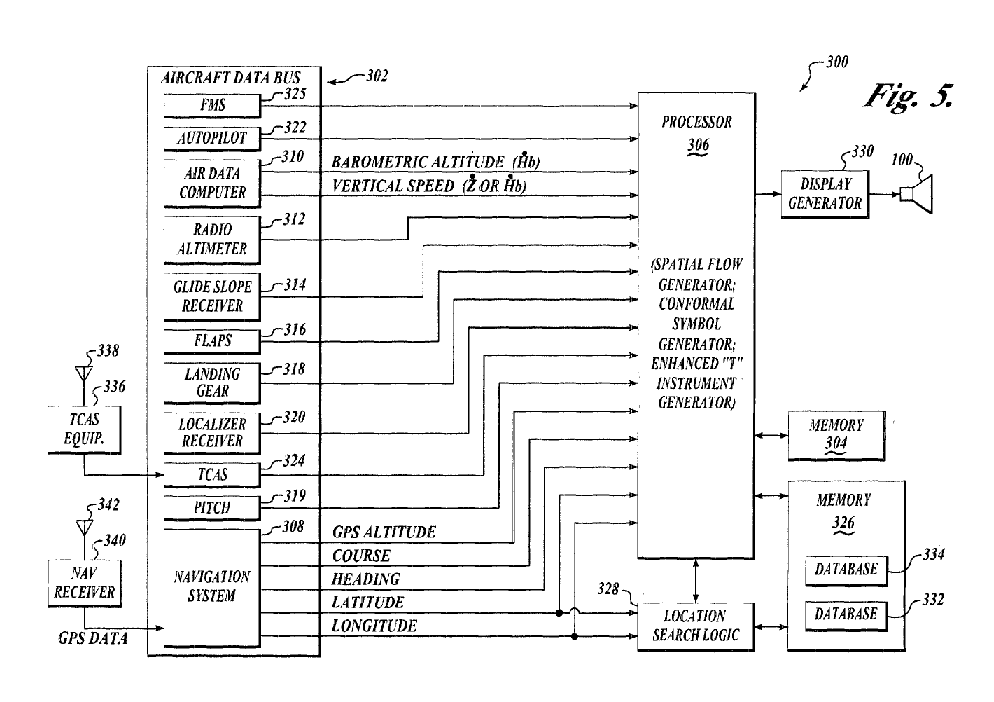

FIG. 5 illustrates by example and without limitation an integrated display presentation system 300 of the invention for tactical flight path management in an aircraft environment embodied as a system block diagram. Accordingly, various signals are provided to the integrated display presentation system 300 of the invention for generating and displaying the integrated display presentation of the invention, including the spatial flow symbology, the conformal symbology, and the enhanced “T” instrument information on the cockpit display 100 shown in FIG. 3 or another suitable head-down or head-up cockpit display device.

The integrated display presentation of the invention is provided as a set of machine instructions received and operated by the onboard automation and presented on the integrated display 100. The machine instructions include instructions for receiving data from one or more of the instrument information signals available on either an aircraft data bus 302 or another suitable means for providing real-time electronic signal data source of instrument signals reporting flight parameter information provides the various signals to the integrated display presentation system 300 of the invention. A detailed description of the signals available on an aircraft data bus 302 is provided by the ARINC Characteristic 429 as published by Aeronautical Radio, Incorporated of Annapolis, Md., the entirety of which is incorporated herein by reference. Included among the signals provided by the aircraft data bus 302 or other suitable source are signals useful for operating the integrated display presentation system 300 of the invention, these signals including by example and without limitation: barometric and radio altitude signals; a vertical speed signal; an air speed signal; navigation signals including GPS altitude, course, heading, latitude and longitude signals; autopilot signals; a radio glideslope signal; flap and gear position signals; pitch indicator signals; localizer receiver signals; and collision avoidance signals.

These signals are used as inputs to an integrated display presentation circuit, which in turn is effective to generate an integrated plurality of display control signals informing the different display presentations of the invention. The integrated plurality of display control signals are applied to a display generator, that in turn generates a plurality of display control signals that result in the spatial flow symbology, conformal symbology, and enhanced “T” instrument information being displayed on the cockpit display 100.

A plurality of machine instructions are stored in an onboard memory 304, which are retrieved and operated by a computer processor 306 to generate the integrated display control signals for generating the integrated display presentation of the invention. The computer processor 306 is for example but without limitation a microprocessor, a digital signal processor, or another suitable processor and may be either a dedicated processor or a processor shared with other onboard equipment. The processor 306 includes inputs coupled to the onboard memory 304 to receive machine instructions and inputs coupled to the data bus 302 to receive sources of instrument signals reporting flight parameter information. The processor 306 uses data received from a navigation system 308 on the aircraft to provide current information about the altitude, course, heading, latitude and longitude of the aircraft. The navigation data may be obtained directly from the navigation system, which may include an inertial navigation system, a satellite navigation receiver such as a GPS receiver, VLF/OMEGA, Loran C, VOR/DME or DME/DME, or from a Flight Management System (FMS).

Information about the barometric altitude, vertical speed and air speed of the aircraft are available from the navigation system 308, from an air data computer 310, or from a barometric altimeter and a barometric rate circuit present on the aircraft. The vertical speed may be expressed as a barometric rate, or as Z velocity, which may be obtained from an onboard inertial navigation system. Alternatively, the simulated visual glideslope indicator system 300 utilizes altitude signals from a radio altimeter 312. The altitude signals are optionally geometric altitude signals generated by the computer processor 306 as a blended combination of the instantaneous GPS altitude signal and the barometric altitude signal as described by Johnson et al. in U.S. Pat. No. 6,216,064, entitled METHOD AND APPARATUS FOR DETERMINING ALTITUDE, issued on Apr. 10, 2001, which is owned by the assignee of the present application and the entirety of which is incorporated herein by reference. Methods and apparatus for determining altitude, specifically altitude in an aircraft, and an estimated error of the altitude are described in U.S. Pat. No. 6,216,064. The altitude determination preferably uses a first altitude based on hydrostatic calculations, including local pressure and temperature, as well as a second altitude which is preferably a GPS altitude. Radio altimetry can also be used instead of or as a complement to the GPS altitude. Other sources of altitude determination can be used in the equation for the calculation of the final altitude. Each of the sources of altitude determination is provided with a complementary estimated error. In the final determination of the probable altitude, each source of altitude information is preferably accorded a weighting according to the estimated error of the altitude source. For global positioning altitude, the final combination of the altitude sources uses a complementary filter which takes into account the selective availability of the GPS altitude. This accounts for the long-term accuracy but short-term inaccuracy of GPS altitude. Corrections are provided to account for horizontal changes in pressure gradient as the aircraft moves from an origin to a destination. The invention described in U.S. Pat. No. 6,216,064 further provides for the altitude to be corrected based on non-standard atmospheric temperature (ISA) variations. In operating the method of U.S. Pat. No. 6,216,064, the computer processor 306 and memory 304 are configured to receive the altitude information and make the necessary calculations to result in an estimate of the current altitude which is then made available to the different operations performed by the integrated display presentation system 300 of the present invention. The computer processor 306 includes inputs to receive sources of altitude information.

A signal from a glideslope receiver 314 may be used to indicate whether an ILS is available to provide a glideslope radio signal. Discrete signals from discretes 316 and 318 indicate the position of the flaps and landing gear, which indicate whether the aircraft is configured for landing, and discrete signals from a pitch indicator discrete 319 indicate the real time aircraft pitch angle. Also available are signals from a localizer receiver 320, which indicate whether the aircraft is on a correct course for a landing.

Signals from the autopilot system 322 may be used to control the aircraft's flight characteristics. TCAS, ACAS or other collision avoidance system signals 324 are also available on the data bus 302 for providing aerial traffic detection and collision avoidance information.

A Flight Management System (FMS) 325 coupled to the data bus 302 has stored therein information about the intended course during the current flight, including information about the positions of waypoints along the aircraft's flight path.

These signals available on the data bus 302 are applied to the processor 306 for enabling the integrated display presentation of the invention according to the different ones of the spatial flow symbology presentation, the conformal symbology presentation, and the enhanced “T” instrument information presentation operations performed by the integrated display presentation system 300 of the invention.

A memory device 326 coupled to the processor 306 stores a plurality of databases of information relevant to performance of the different operations of the invention. A location search logic device 328 is coupled between the memory device 326 and the processor 306 for accessing one of the databases during performance of one or more of the different operations of the invention.

Using the data supplied by the different instrument and aerial traffic detection and collision avoidance information signals available on the data bus 302, the processor 306 operates one or more algorithms for generating the plurality of display control signals, including the spatial flow symbology signals, conformal symbology signals, and enhanced “T” instrument information signals, as illustrated in FIG. 3 and described in detail below. The display control signals are output to a display generator 330 that interprets the display control signal to generate the spatial flow symbology, conformal symbology, and enhanced “T” instrument information displays on the display 100.

According to one embodiment of the invention, the integrated display presentation information of the invention, including the spatial flow symbology, conformal symbology, and enhanced “T” instrument information displays are displayed on the display 100, which is embodied as a liquid crystal display (LCD). When the display 100 is embodied as a color LCD, the integrated display presentation information are displayed as described herein. However, when the display 100 is embodied as a black and white LCD, the integrated display presentation information are displayed in shades of gray, for example, as illustrated in Figures.

Spatial Flow

The integrated display presentation system 300 as embodied in FIG. 5 includes a plurality of machine instructions stored in the onboard memory 304, which are retrieved and operated by a processor 306 to generate the simulated visual field of view (FOV) on the display 100. The processor 306 receives an altitude data signal from one of the altitude data signals sources on the data bus 302 to provide current information about the altitude of the aircraft. The altitude data are applied to the processor 306 for enabling the expanded FOV, including the horizon 107.

An additional plurality of machine instructions stored in the onboard memory 304 are retrieved and operated by the processor 306 to generate coloration of either or both the sky 102 and ground 104 when the display 100 is a color display, thereby assisting depth perception. Optionally, the machine instructions stored in the onboard memory 304 and retrieved by the processor 306 are operated to generate shading of either or both the sky 102 and ground 104 that increases toward the horizon 107, thereby replicating color gradations in either or both the sky 102 and ground 104 that further assist depth perception.

Further machine instructions stored in the onboard memory 304 are retrieved and operated by the processor 306 to generate the horizontal and longitudinal perspective lines 106 superimposed on the ground 104, the longitudinal perspective lines 106 converging to a common vanishing point on the horizon 107, thereby further assisting depth perception.

Optionally, machine instructions stored in the onboard memory 304 are retrieved and operated by the processor 306 to generate the texture cues 105 superimposed on the ground 104, which further assist depth perception. The texture cues 105 is either applied randomly or as a function of actual ground texture determined from a database 332 stored in the memory device 326 and containing terrain information as a function of position, such as a position defined by latitude and longitude values. In such instance, the processor 306 additionally retrieves real time position information available on the data bus 302 and, using the position information, retrieves terrain information as a function of the real time aircraft position and retrieves further terrain information as a function of the real time aircraft heading and projected along the heading even as far as the horizon 107 and the lateral extents of the FOV. The processor further optionally operates machine instructions retrieved from the memory 304 to superimpose the terrain texture cues 105 on the ground 104 as a function of real time altitude of the aircraft so that the terrain appears substantially as if viewed through the cockpit windshield. The randomly applied or real time terrain cues 105 is moved down toward the bottom of the screen of the display 100 to represent actual terrain moving past underneath the aircraft.

The processor 306 optionally retrieves real-time air speed information available on the data bus 302 and, using the air speed information, moves the terrain cues 105 over the display screen as a function of the real-time air speed of the aircraft. The aircraft air speed value used in moving the terrain cues 105 over the display screen is optionally a true air speed that is adjusted for wind effects to reflect actual speed over the ground.

The immergent features: texture, perspective, and color, are thus recreated and integrated in the cockpit display 100 by the integrated display presentation 300 of the invention being operated by the onboard processor 306. The integrated picture of cues of texture, perspective, and color provided by the integrated display presentation 300 on the cockpit display 100 reproduce “optical flow,” Which improves situational awareness SA.

Furthermore, according to the invention, any one or more of the different immergent features are optionally recreated on the cockpit display 100 either independently or in combination one or both of the other immergent features. A degree of optical flow is thereby reproduced using minimal processing power.

Conformal Symbology

The integrated display presentation system 300 as embodied in FIG. 5 includes a plurality of machine instructions stored in the onboard memory 304, which are retrieved and operated by a processor 306 to generate simulated terrain object cues 105 on the display 100, whereby outside relationships are replicated on the display 100 inside the aircraft. The simulated terrain object cues 105 are alternatively rendered on the display 100 using true one-to-one mapping or a compressed mapping that maximizes the amount of information presented on the display. The integrated display presentation system 300 thus presents terrain object information using symbology that substantially mimics the form of the objects as they appear in the far domain. In other words, the terrain object cues 105 are presented in positions consistent with a view of terrain as seen on from the cockpit, which the pilot to utilize pre-attentive referencing rather than conscious decision, thereby reducing pilot workload.

U.S. Pat. No. 5,745,863, THREE DIMENSIONAL LATERAL DISPLACEMENT DISPLAY SYMBOLOGY WHICH IS CONFORMAL TO THE EARTH, which is incorporated herein by reference, illustrates well-known means for computing and implementing symbology conformal with the earth's surface. Those skilled in the art can readily adapt these calculations or use substantially similar calculations, including embodiments using satellite position and altitude systems such as the global positioning system(GPS) and the like, for computing and implementing the conformal symbology of the present invention. These calculations are straight forward using basic trigonometry, as disclosed in U.S. Pat. No. 5,745,863.

Accordingly, those of ordinary skill in the art can use generally well-known calculations adapted from or substantially similar to the calculations disclosed by U.S. Pat. No. 5,745,863 in combination with known aircraft position and altitude information (retrieved from onboard instruments) and known terrain position and altitude information (retrieved from a database) to compute and implement terrain symbology conformal with the earth's surface as it would appear from the cockpit if visible. Additional conformal symbology elements include without limitation: the conformal lateral deviation indicator cues 112; the conformal lateral path indication cues 114; the conformal lateral current and next waypoint cues 116, 118, the conformal PLI (pitch limit indicator) cue 138, e.g., the conformal pitch scale cue 140 or pitch reference 142; and the conformal runway/airport symbol 110. Well-known means similar to those used for computing and implementing the conformal terrain symbology of the invention are used for computing and implementing these additional conformal symbology elements of the present invention. Accordingly, those of ordinary skill in the art can use generally well-known calculations adapted from or substantially similar to the calculations disclosed by U.S. Pat. No. 5,745,863 in combination with known aircraft position and altitude information and other known information (retrieved from onboard databases or other onboard instruments) to compute and implement the additional conformal symbology elements of the present invention. These additional conformal symbology elements are also rendered on the display 100 using true one-to-one mapping or a compressed mapping that maximizes the amount of information presented on the display.

Furthermore, according to the present invention, any one or more of the plurality of different conformal symbology display control signals for presenting one or more of the plurality of different conformal symbology information displays, including one or more of the conformal lateral deviation indicator cues 112, the conformal lateral path indication cues 114, conformal visual landmarks such as the conformal lateral current and next waypoint cues 116, 118, the conformal PLI cue 138, and the conformal runway/airport symbol 110, is optionally operated independently or in combination with any one or more of the other plurality of the different conformal symbology presentations. Thus, the different conformal symbology presentations can be presented on the display independently or in any combination with the other conformal symbology presentations within the integrated display presentation system 300.

The processor 306 receives altitude and position data signals from respective altitude and position data signals sources on the data bus 302 to provide current information about the altitude, position, course and heading of the aircraft. The altitude and position data are applied to the processor 306 for enabling the conformal lateral deviation indicator and lateral path indicator cues 112, 114 relative to the aircraft's current position and the desired course along the ground.

The scale of the conformal lateral deviation indicator and lateral path indicator cues 112, 114 are presented relative to the aircraft's current altitude, the machine instructions thus drive the processor 306 to operate an algorithm for varying the scaling or distance between the conformal lateral deviation indicator trapezoids 112 as a function of the aircraft's estimated altitude above ground. Accordingly, as the aircraft approaches closer to the ground, the deviation indicator cues 112 and the distance between them become larger. The perspective view presented by the deviation indicator cues 112 also aids the pilot in recognizing distance to the airport, thereby assisting with subconscious pre-attentive referencing.

Visual landmarks, such as a mountain peak on the horizon, provide situation awareness by helping guide a pilot to a destination. When flying IMC, these landmarks are not available. The conformal lateral current and next waypoint cues 116, 118 substitute for such landmarks by replicating an element common to visual flight, thereby increasing SA and contributing to visual momentum.

Additional machine instructions stored in the memory 304 are operated by the processor 306 for enabling the conformal lateral current and next waypoint cues 116, 118 relative to the aircraft's current position and heading. Information for locating the current and next waypoints and the cues 116, 118 are stored in the aircraft's FMS device 325. The machine instructions drive the processor 306 to access position and heading data available on the data bus 302 as well as positions of the current and next waypoints and to operate an algorithm for determining the positions of one or both of the lateral current and next waypoints relative to the aircraft's current position. The machine instructions further drive the processor 306 to operate an algorithm for positioning in real time the lateral current and next waypoint cues 116, 118 conformally relative to the aircraft's current position and heading as a function of the relative positions of the lateral current and next waypoints. The machine instructions drive the processor 306 to vary the conformal positions of the lateral current and next waypoints as a function of the real time deviations from the current position and heading.

Spatial disorientation occurs when a pilot is deprived of visual references to determine the aircraft's orientation in space. Loss of directional control may occur if the pilot is not aware of the bounds of pitch, and a stall/spin or a stall/mush can be a deathly result. Around 50% of GA accidents can be attributable to lost control or the stall/spin/mush condition. The conformal PLI 138 provides visual cues to the approach of stall conditions and is thus a very salient cue that dramatically increases awareness of approach to stall condition and enhance safety.

Additional machine instructions stored in the memory 304 are operated by the processor 306 for enabling the conformal PLI 138 relative to the aircraft's current pitch. The machine instructions drive the processor 306 to access discrete pitch data available on the data bus 302 and to operate an algorithm for determining the aircraft's current pitch attitude. The machine instructions drive the processor 306 to vary the conformal PLI 138 as a function of the real time pitch indicator data. The conformal PLI 138 is presented conformally about the pitch ladder 140 or pitch scale 142 on the center of the display 100 having substantially the same attitude that a stick shaker, if present, would start to shake.

Furthermore, yet additional machine instructions stored in the memory 304 are operated by the processor 306 for enabling the conformal pitch tape or pitch scale 140 and horizon 107 relative to the aircraft's current pitch. The processor 306 is thus enabled for presenting the aircraft's conformal attitude on the display 100 whereby 1 degree on the display is substantially equal to 1 degree as viewed through the cockpit windscreen. The machine instructions drive the processor 306 to access discrete pitch data available on the data bus 302 and to operate an algorithm for determining the aircraft's current pitch attitude. The machine instructions drive the processor 306 to vary the conformal pitch scale 140 and horizon 107 as a function of the real time pitch data. The conformal pitch scale 138 and horizon 107 are presented conformally on the center of the display 100 having differently colored solid ticks for positive and negative pitch, e.g., light blue ticks for positive pitch and brown ticks for negative pitch. Additionally, the machine instructions drive the processor 306 to present markers on the horizon 107 at regular intervals. For example, light blue ticks are presented on the horizon 107 line at 10 degree intervals.

The ball/attitude indicator 126 is provided in as large an image as the display 100 permits. Larger displays permit a pilot to more easily discriminate upsets to pitch due to the increase in periphery field of view. When a pilot can quickly detect a disturbance, a corrective action can be quickly made, thereby improving overall performance, i.e., on track, on altitude, on speed performance. Overall workload is also reduced because the earlier a pilot catches a problem, the more quickly the problem can be resolved so that less cognitive and physical exertion is required to maintain overall performance. The conformal PLI 138, pitch scale, pitch reference, and horizon cues 140, 142, 107 also greatly improve safety by providing early recognition so that the pilot is less likely to get into an unrecoverable condition. For example, in the example of windshear, if a pilot can detect it early by means of a disturbance to intended attitude and path, she can respond earlier and is therefore less likely to get into an unrecoverable condition. The use of conformal symbology thus provides visual momentum to out-the-window-view.

When in range of an airport, the conformal runway/airport cues 110 are presented on the display 100 to provide a means for pre-attentive referencing whereby the pilot workload is reduced by providing visual cues that permit the pilot to dispense with conscious decision making. Thus, additional machine instructions stored in the memory 304 are retrieved and operated by the processor 306 for enabling the conformal runway/airport cues 100 relative to the aircraft's current position, heading and altitude. The machine instructions drive the processor 306 to access position, heading and altitude data available on the data bus 302. The machine instructions also drive the processor 306 to request airport and runway information from the location search logic circuit 328. The location search logic 328 uses either the latitude and longitude data supplied by the navigation system 308 (shown) or information from the flight plan stored in the onboard FMS to access a database 334 of airport and runway information stored in the onboard memory 326.

The machine instructions drive the processor 306 to operate an algorithm for determining the positions of the airport and runway relative to the aircraft's current position. The machine instructions further drive the processor 306 to operate an algorithm for generating the runway/airport cues 110 conformally as a function of altitude relative to the aircraft's current position and heading.

The machine instructions drive the processor 306 to generate the airport portion of the symbol 10 when the aircraft is above about 1,000 feet above ground level (AGL) because the airport's relative size makes it visible. As the aircraft approaches the ground, the machine instructions drive the processor 306 to generate the runway portion of the symbol 110, and the airport portion is removed from the display. As discussed herein, the machine instructions drive the processor 306 to generate the conformal runway/airport symbol 110 using horizontal and longitudinal line segments to appear conformal to a flat surface on the ground. The algorithm operated by the processor 306 causes the longitudinal line segments to terminate at fixed depression angles which determine Y coordinates for the line end points. X coordinate end points of the longitudinal lines are based on a quantity commonly referred to as “inverse slope” so that if the longitudinal lines were extended, the end points would theoretically extend to a common vanishing point on the horizon 107 and to a point directly below the aircraft.

Furthermore, the machine instructions drive the processor 306 to regularly update the relative size and position of the airport and runway as a function of the aircraft's real time position, heading and altitude so that the runway/airport symbol 110 is sized and positioned on the display 100 such that its image overlays the actual airport as seen from the pilot's position with the images presented on the display 100 substantially conforming to actual features on the ground as seen on approach from the aircraft's cockpit. The conformal display 100 assists with subconscious pre-attentive referencing and bypasses conscious decision making. The conformal display 100 has been shown to reduce pilot workload while improving pilot tracking performance.

The machine instructions thus drive the processor 306 to vary the conformal size and positions of the runway and airport cues 10 as a function of the real time changes in relative position, heading and altitude so as to present the airport and runway on the display 100 in their perceived position in depth and thereby replicate cues basic to visual flight.

Additional machine instructions stored in the memory 304 are operated by the processor 306 for enabling the conformal TCAS or ACAS aerial traffic detection and collision avoidance information relative to the aircraft's current position, heading and altitude.

The machine instructions drive the processor 306 to operate an algorithm for receiving current TCAS or ACAS aerial traffic detection and collision avoidance information from an onboard TCAS or ACAS equipment 336 that receives transponder signals from intruder aircraft via an antenna 338. The machine instructions further drive the processor 306 to operate the algorithm for determining the positions of intruding aircraft relative to the protected host aircraft's current position, heading and altitude. The machine instructions further drive the processor 306 to operate an algorithm for isolating that portion of the information that lies within the scope of the illustration of the “real world” provided on the display 100, i.e., that portion or “slice” of the TCAS information relevant to the wedge shaped field of view (FOV) encompassed by the integrated display 100 of the invention. The machine instructions further drive the processor 306 to operate an algorithm for generating the aerial traffic cues conformally as a function of altitude relative to the aircraft's current position and heading. For example, the algorithm generates each indicia or tag 202, 204, 206 that represents aerial traffic within the horizontal and vertical extents of the wedge shaped FOV presented by the integrated display 100 of the invention.

Well-known means adapted from or substantially similar to the calculations disclosed by U.S. Pat. No. 5,745,863 are used in combination with aircraft and aerial traffic information for computing and implementing the conformal aerial traffic symbology of the present invention. Accordingly, it is generally well-known to those of ordinary skill in the art to use generally well-known calculations in combination with known aircraft position and altitude information (retrieved from onboard instruments) and aerial traffic relative position and altitude information (retrieved from an aerial traffic detection and collision avoidance system such as TCAS or ACAS) to compute and implement aerial traffic symbology conformal with the earth's surface. The algorithm for rendering the TCAS information on the display 100 utilizes either true one-to-one mapping or the compressed mapping discussed herein that maximizes the amount of information presented on the display.

Using conventional TCAS threat level indicators, the threat level of each intruder aircraft within the FOV presented by the display 100 is also repeated in combination with the corresponding indicia or tag 202, 204, 206 that represents the intruder. Conventional TCAS symbology is also used to represent the relative altitude difference between the protected host aircraft and the intruder aircraft; whether the intruder is above or below the host aircraft; the two digit number that provides a visual cue as to the intruder aircraft's relative position; and the vertical arrow indicator of the intruder's altitude rate of change.

Furthermore, the machine instructions drive the processor 306 to regularly update the relative position of the aerial traffic detection and collision avoidance information as a function of the protected host aircraft's real time position, heading and altitude.

When the protected host aircraft is provided with the improved four-antenna TCAS system as taught by U.S. Pat. No. 4,855,748, the TCAS equipment provides and utilizes knowledge of the relative bearing of the intruding aircraft from the protected aircraft, in addition to the other data normally collected by standard TCAS equipment, to provide advisories for horizontal right or left turn maneuvers as well as for vertical maneuvers. Additional machine instructions drive the processor 306 to repeat the TCAS advisories for horizontal right or left turn maneuvers as well as for vertical maneuvers.

Other machine instructions drive the processor 306 to repeat the TCAS text displays wherein conditions of the TCAS are reported. The TCAS text displays are repeated in one or more of the areas represented by rectangular boxes 208, 210, 212, 214, 216 of the integrated display 100 of the invention.

Enhanced “T” Instrumentation

The enhanced “T” instrumentation information includes by example and without limitation: barometric and radio altitude instrumentation information; vertical speed instrumentation information; air speed instrumentation information; navigation instrumentation information including GPS altitude, course, heading, latitude and longitude instrumentation information; autopilot instrumentation information; radio glideslope instrumentation information; flap and gear position instrumentation information; localizer receiver instrumentation information; and radio communication instrumentation information.

These signals are available to the processor 306 via the data bus 302 and are used as inputs to an algorithm operated by the processor 306 for generating the enhanced “T” instrumentation information displays on the cockpit display 100 or another suitable cockpit display. Accordingly, additional machine instructions stored in the memory 304 are retrieved and operated by the processor 306 for enabling a plurality of the enhanced “T” instrumentation information displays of the invention, including one or more of the altitude instrumentation information display 128; the pictographic mode information display 134 including the vertical speed instrumentation information display with the pointer 136; the air speed instrumentation information display 120; and optionally one or more of a plurality of instrumentation information display that are not shown, including but not limited to radio communications and navigation instrumentation information display portion having navigation instrumentation information displays of one or more of GPS altitude, course, heading, latitude and longitude instrumentation information; an autopilot instrumentation information display; a radio glideslope instrumentation information display; a flap and a gear position instrumentation information display; and a localizer receiver instrumentation information display.

A plurality of machine instructions stored in the onboard memory 304, which are retrieved and operated by a processor 306 to generate the enhanced “T” instrumentation information displays. The machine instructions drive the processor 306 to access a plurality of signals available on the data bus 302 including by example and without limitation: the barometric and radio altitude signals; the vertical speed signal; the air speed signal; the navigation signals including one or more of the GPS altitude, the course, the heading, the latitude and the longitude signals; the autopilot signals; the radio glideslope signal; the flap and gear position signals; the localizer receiver signals; and the radio communication signals. These signals are applied to the processor 306 for generating some or all of the enhanced “T” instrumentation information displays.

The machine instructions drive the processor 306 to operate an algorithm for determining a current mode or phase of flight as a function of the several instrument information signals available on the data bus 302 that are indicative of different flight parameters. The machine instructions further drive the processor 306 to operate an algorithm for dynamically emphasizing one or more of the different information displays as a function of the current mode or phase of flight by metamorphosis or transformation in appearance using any of animated size, font, shading and texture, as discussed herein.

Simulated Visual Glideslope Indicator

In addition to the instrumentation information displays described above, the enhanced “T” instrumentation information displays include the simulated visual glideslope indicator display 148, also known by the sobriquet “Virtual VASI,” which is exemplified in FIG. 3 and described more completely in co-pending U.S. patent application Ser. No. 10/052,716, entitled SIMULATED VISUAL GLIDESLOPE INDICATOR ON AIRCRAFT DISPLAY, which is incorporated herein by reference. Accordingly, various signals are provided to the integrated display presentation system 300 of the invention for generating and displaying the simulated visual glideslope indicator display 148. For example, either an aircraft data bus 302 or another suitable means for providing real-time electronic signal data provides the various signals to the processor 306 for generating and displaying the simulated visual glideslope indicator display 148. These signals are used as inputs to a simulated glideslope circuit or algorithm operated by the processor 306, which generates a simulated visual glideslope signal whenever the various flight parameters indicate that the aircraft is on an approach. The simulated visual glideslope signal is applied to the display generator 330, that in turn generates a simulated visual glideslope indicator signal that results in simulated visual glideslope indicator display 148 being presented on the integrated display 100 illustrated in FIG. 3.

For example, the simulated visual glideslope circuit or algorithm receives a plurality of machine instructions stored in the onboard memory 304, which are retrieved and operated by a processor 306 to generate the simulated glideslope indicator display 148. The navigation system signal 308 provides current information about the altitude, course, heading, latitude and longitude of the aircraft. The navigation data may be obtained directly from the navigation system, which may include an inertial navigation system, a satellite navigation receiver such as a GPS receiver, VLF/OMEGA, Loran C, VOR/DME or DME/DME, or from a flight management system (FMS).

Information about the barometric altitude of the aircraft and the vertical speed of the aircraft are available from the navigation system 308, from an air data computer 310, or from a barometric altimeter and a barometric rate circuit present on the aircraft. The vertical speed may be expressed as a barometric rate, or as Z velocity, which may be obtained from an onboard inertial navigation system. Alternatively, the processor 306 utilizes altitude signals from a radio altimeter 312. The altitude signals are optionally geometric altitude signals generated by the computer processor 306, as described briefly herein and in U.S. Pat. No. 6,216,064, which is incorporated by reference herein. The computer processor 306 includes inputs to receive sources of altitude information.

The processor 306 may receive a signal from a glideslope receiver 314 to determine whether an ILS is available to provide a glideslope radio signal. The processor 306 may receive discrete signals from discretes 316 and 318 to determine the position of the flaps and landing gear, which indicate whether the aircraft is configured for landing. The processor 306 may also receive signals from a localizer receiver 320 to determine whether the aircraft is on the correct course for a landing.

The signals from the glideslope receiver 314, and the flap and landing gear discretes 316 and 318 are applied to the processor 306 for enabling the simulated visual glideslope indicator display 148. When a request for the simulated visual glideslope indicator display 148 is received by the processor 306, the signals from the glideslope receiver 314, and the flap and landing gear discretes 316 and 318 may be interrogated by the processor 306 to determine whether an ILS system is available at the target runway and whether the aircraft is configured for landing. The signals from the localizer receiver 320 may be interrogated by the processor 306 to determine whether the aircraft is aligned with the runway. Such information signals are optionally used by the processor 306 to disable the simulated visual glideslope indicator display 148.

The request stimulates the simulated visual glideslope indicator generator operated by the processor 306 to request airport and runway information from the location search logic circuit 328. The location search logic 328 uses either the latitude and longitude data supplied by the navigation system 308 (shown) or information from the flight plan stored in the onboard FMS to access a database of airport and runway information stored in an onboard memory 326.

The request also stimulates the processor 306 to operate the algorithm for generating the simulated visual glideslope indicator display 148, including the glideslope target 148a and the needle or pointer 148b, illustrated in FIG. 3. Using the altitude, latitude and longitude data supplied by the navigation system 308, the glideslope generator circuit or algorithm is operated by the processor 306 to determine a physical relationship of the aircraft to the target runway. The current relationship is compared with either a stored set of relationship data or with subsequent relationship data to compute an accurate speed over the ground, a vertical speed, a course and a heading, unless these information are otherwise available, e.g., from the air data computer 310 and navigation system 308. The glideslope generator either computes an acceptable glideslope to the target runway that includes acceptable deviations from an ideal or preferred glideslope, or retrieves a predetermined glideslope from the database 334 of runway and airport information stored in the memory 326 via the search logic 328 as a function of the position of the aircraft as supplied by the navigation system 308. The computed or retrieved glideslope may optionally include modifications for local obstacles to flight and elevated terrain that affect the approach to the airport, if such information are available.

The glideslope generator compares the computed relationship of the aircraft to the target runway with the computed ideal or preferred glideslope to determine coincidence and computes the degree and direction of any deviation from the ideal or preferred glideslope. The comparison is used by the processor 306 to generate display control signals that indicate the coincidence or the degree and direction of deviation from the ideal or preferred glideslope. The display control signals are output to the display generator 330 that interprets the display control signal to generate the simulated visual glideslope indicator display 148 on the display 100 in a fashion that mimics a VASI or PAPI system or another airport lighting aid appropriate for the target runway. Thus, the display generator 330 interprets the display control signal to generate a pattern of indicators 148 on the display 100 such that, when the aircraft is on the computed glideslope, black or red colored indicators are illuminated over white colored indicators. Above the computed glideslope, white colored indicators are illuminated over other white colored indicators, and below the computed glideslope black or red colored indicators are illuminated over other black or red colored indicators.

Furthermore, the display generator 330 interprets the display control signal to generate a scalar color transition between visible indicators 148 such that, as illustrated in FIG. 3, the second indicator from the bottom is colored gray or pink (shown shaded) to indicate the slightly below path condition. Similarly, a slightly above path condition could be indicated by showing the second indicator from the top being shaded gray or pink.

Additionally, the display generator 330 interprets the display control signal to generate the visual glideslope target 148a between the upper and lower visible indicators 148 such that, as illustrated in, the target 148a provides a visual target for the pilot to acquire and maintain during approach.

The display generator 330 also interprets the display control signal to generate the needle pointer 148b for simulating a traditional vertical deviation scale. The simulated visual glideslope indicator needle 148b indicates the vertical position of the aircraft relative to the ideal or preferred glideslope, and thereby provides additional visual information as to the degree of deviation from the computed ideal or preferred glideslope.

The display generator 330 also optionally interprets the display control signal to generate the simulated visual glideslope indicator display 148 as a conformal display such that the indicators of the display 148 are presented approximately at the position where ground-based VASI, if available, would be visible from the cockpit.

The processor 306 is optionally equipped with minimum confidence thresholds for the position and altitude data such that the simulated visual glideslope indicator display 148 may be disabled when the available information is insufficient to calculate a valid approach glideslope.

The processor 306 optionally receives the glideslope receiver signal 314 and operates machine instructions to disable the simulated visual glideslope indicator display 148 to avoid correlation problems when a ground-based runway visual aid is available.

Pictographic Mode Awareness Display

The enhanced “T” instrumentation information displays additionally include the pictographic information display 134, which is exemplified in FIG. 3 and described more completely in co-pending U.S. patent application Ser. No. ______ (Attorney Docket No. H0001712), entitled PICTOGRAPHIC MODE AWARENESS DISPLAY FOR AIRCRAFT, which is incorporated herein by reference. Accordingly, various signals are provided to the integrated display presentation system 300 of the invention for generating and displaying the pictographic information display 134. For example, either an aircraft data bus 302 or another suitable means for providing real-time electronic signal data provides the various signals to the processor 306 for generating and displaying the pictographic information display 134. These signals are used as inputs to a pictographic information display circuit or algorithm operated by the processor 306, which generates a pictographic information display control signal as a function of various flight parameters that indicate the aircraft's current and next mode of flight. The pictographic information display control signal is applied to the display generator 330, that in turn generates a pictographic information display control signal that results in the pictographic information display 134 being presented on the display 100 illustrated in FIG. 3.

Machine instructions stored in the memory 304 are retrieved and operated by the processor 306 for enabling the pictographic information display 134, whereby the pictographic information display 134 is presented on the display 100 having first and second coexisting adjacent areas 222, 224 including respective visual alphanumeric current mode enunciator and optionally one of currently non-operational or next mode enunciators as disclosed in U.S. patent application entitled PICTOGRAPHIC MODE AWARENESS DISPLAY FOR AIRCRAFT. Additional machine instructions stored in the memory 304 are retrieved and operated by the processor 306 for enabling the pictographic information display 134 to present one or both of the directional mode enunciator and an alphanumeric vertical speed enunciator.

The machine instructions operated by the processor 306 for enabling the pictographic information display 134 include instructions operable by the processor 306 for determining current and armed operational modes of the navigation and autopilot systems, as well as current vertical speed value and slope and generate a control signal informing a pictographical representation symbolic of the current and armed modes of operation, and the current value and slope of vertical speed.

The machine instructions include instructions operable by the processor 306 for receiving a signal representative of a current mode of operation of one or more instrument systems, such as navigation and autopilot instrument systems; instructions for determining a current mode of operation of the instrument system from the current mode of operation information; and instructions for generating and outputting a display control signal informing a pictographical representation symbolic of the current mode of operation.

Computer Program Product

In addition to being practiced as apparatus and methods, the present invention is also practiced as a computer program product for generating and displaying the integrated display presentation of the invention, including the spatial flow symbology, the conformal symbology, and the enhanced “T” instrument information on the cockpit display 100 shown in FIG. 3 or another suitable cockpit display device. The computer program product of the invention includes a computer-readable storage medium having computer-readable program code means embodied in the medium. With reference to FIG. 5, the computer-readable storage medium may be part of the memory device 304, and the processor 306 of the present invention implements the computer-readable program code means for receiving sources of instrument signals reporting flight parameter information and generating a plurality of display control signals informing one or more of the spatial flow symbology presentation, the conformal symbology presentation, and the enhanced “T” instrument information presentation. The different computer-readable program code means for receiving sources of instrument signals reporting flight parameter information and for generating different ones of the plurality of display control signals are optionally present and operated individually or in combination with one or more of the other computer-readable program code means of the present invention.

Spatial Flow

The computer-readable program code means includes a first computer-readable program code means for receiving one or more of a source of instrument signals reporting a plurality of flight parameter information; at least a second computer-readable program code means for generating one or more of a plurality of spatial flow symbology display control signals, a plurality of conformal symbology display control signals, and a plurality of enhanced “T” instrument information display control signals. When the second computer-readable program code means is computer-readable program code means for generating one of a plurality of spatial flow symbology display control signals, the second computer-readable program code means are configured as computer-readable program code means for recreating one or more immergent features in the cockpit display 100, the possible immergent features including without limitation: texture, perspective, and color. Thus, when the second computer-readable program code means is computer-readable program code means for generating one of a plurality of spatial flow symbology display control signals, the computer-readable program code means includes a third computer-readable program code means for receiving an altitude data signal and fourth computer-readable program code means for generating an expanded FOV display control signal, including a horizon signal informing the display of the horizon 107 illustrated in FIG. 3. Optionally, fifth computer-readable program code means may be included for generating coloration display control signals for applying coloration to either or both the sky 102 and ground 104 portions of the display 100 when the display 100 is a color display. Optionally, sixth computer-readable program code means may be included for generating shading display control signals for applying shading to either or both the sky 102 and ground 104 portions of the display 100 when the display 100 is a either a color display or a two-color display such as a black-and-white display.

Additionally, seventh computer-readable program code means may be included for generating perspective display control signals informing one or both of horizontal and longitudinal perspective lines, such that horizontal and longitudinal perspective lines 106 are superimposed on the ground 104 with the longitudinal perspective lines 106 converging toward a common vanishing point on or near the horizon 107.

Additionally, eighth computer-readable program code means may be included for generating texture display control signals for applying texturing on the ground 104 portion of the display. The eighth computer-readable program code means for generating texture display control signals may include computer-readable program code means for generating texture display control signals representative of random texture. The eighth computer-readable program code means for generating random texture display control signals may include computer-readable program code means for accessing instrument data signals representative of motion over the ground, e.g., navigation or air speed signals, determining either indicated or true air speed, and computer-readable program code means for generating random texture display control signals moving across the display as a function of the determined indicated or true air speed.

Alternatively, the eighth computer-readable program code means for generating texture display control signals may include computer-readable program code means for accessing navigation data signals, determining a substantially real time position of the aircraft, accessing a database 332 of actual ground texture as a function of position, and generating texture display control signals representative of actual ground texture. The eighth computer-readable program code means for generating texture display control signals representative of actual ground texture further include computer-readable program code means for updating the position information by regular sampling of the navigation data signals and generating the texture display control signals as a function of the updated position information.

Conformal Symbology

When the second computer-readable program code means is computer-readable program code means for generating of a plurality of conformal symbology display control signals, the second computer-readable program code means includes computer-readable program code means for rendering the conformal symbology using one or both of true one-to-one mapping, or conformal compressed symbology in which the information is rendered using mapping that is not a true one-to-one mapping whereby the information on the display is maximized, as discussed herein. The second computer-readable program code means for rendering the conformal symbology includes computer-readable program code means for generating one or more simulated aerial traffic cues and terrain object cues for presentation on the cockpit display 100, the simulated terrain object cues including without limitation: the barometric and radio altitude instrumentation information; the vertical speed instrumentation information; the air speed instrumentation information; the navigation instrumentation information including GPS altitude, course, heading, latitude and longitude instrumentation information; the autopilot instrumentation information; the radio glideslope instrumentation information; the flap and gear position instrumentation information; the localizer receiver instrumentation information; and the aerial traffic detection and collision avoidance information.

Thus, when the second computer-readable program code means is computer-readable program code means for generating one of a plurality of conformal symbology display control signals, the second computer-readable program code means includes a third computer-readable program code means for receiving altitude, position, course and heading signals and fourth computer-readable program code means for generating display control signals informing one or both of the conformal lateral deviation indicator and lateral path indicator cues 112, 114 relative to the aircraft's current position and the desired course along the ground. Optionally, when the fourth computer-readable program code means is computer-readable program code means for generating display control signals informing the conformal lateral deviation indicator cues 112 as trapezoids, the fourth computer-readable program code means further includes computer-readable program code means for varying the scaling or distance between the conformal lateral deviation indicator trapezoids 112 as a function of the aircraft's determined altitude above ground, the fourth computer-readable program code means further includes computer-readable program code means for varying the scaling or distance between the conformal lateral deviation indicator trapezoids 112 further including computer-readable program code means for updating the altitude information by regular sampling of the navigation data signals and varying the scaling as a function of the updated altitude information.

The second computer-readable program code means for generating one or more of a plurality of plurality of conformal symbology display control signals optionally includes the third computer-readable program code means for receiving altitude, position, and course signals, as well as FMS data signals informing the positions of the current and next waypoints. Fourth computer-readable program code means are included for locating one or both of the current and next waypoints relative to the aircraft's current position and course and generating display control signals for locating one or more of the conformal visual landmarks on or near the horizon 107 relative to the aircraft's current position and course. The visual landmarks are optionally the conformal lateral current and next waypoint cues 116, 118 described herein.

The fourth computer-readable program code means for locating and generating one or both of the current and next waypoints further includes computer-readable program code means for updating the relative position information by regular sampling of the navigation data signals and generating the display control signals for the conformal lateral current and next waypoint cues 116, 118 as a function of the updated position information.

The second computer-readable program code means for generating one or more of a plurality of plurality of conformal symbology display control signals may include third computer-readable program code means for receiving discrete pitch indicator signals 319. Fourth computer-readable program code means are included for generating display control signal locating the PLI 138 conformally on or near on the center of the display 100 as a function oft the aircraft's current pitch attitude. The fourth computer-readable program code means for generating display control signal locating the conformal PLI 138 further includes computer-readable program code means for updating the pitch attitude information by regular sampling of the pitch indicator data signals 319 and generating the display control signals for the conformal PLI 138 as a function of the updated pitch attitude information.

The second computer-readable program code means for generating one or more of a plurality of plurality of conformal symbology display control signals and including the third computer-readable program code means for receiving discrete pitch indicator signals 319 may include in the alternative or in combination with the computer-readable program code means for generating display control signal locating the conformal PLI (pitch limit indicator) 138, computer-readable program code means for generating display control signal locating the conformal pitch tape or pitch scale 140 and horizon 107 as a function oft the aircraft's current pitch attitude. The fourth computer-readable program code means for generating display control signal locating the conformal pitch scale 140 further includes computer-readable program code means for updating the pitch attitude information by regular sampling of the pitch indicator data signals 319 and generating the display control signals for the conformal pitch scale 140 as a function of the updated pitch attitude information.

The second computer-readable program code means for generating one or more of a plurality of plurality of conformal symbology display control signals optionally includes the third computer-readable program code means for receiving altitude, position, course and heading signals. Fourth computer-readable program code means are included for accessing the database 334 of airport and runway information stored in the onboard memory 326 as a function of the position information. The fourth computer-readable program code means for accessing the database 334 of airport and runway information may optionally include accessing the database 334 as a function of the course or heading information, as in the case of multiple airports in the vicinity.

Additional computer-readable program code means are included for determining the positions of one or both of the airport and runway relative to the aircraft's current position and heading, and generating display control signals for conformally locating one or both of the airport and runway symbols 110 superimposed on the ground portion 104 of the display relative to the aircraft's current position and heading.

The computer-readable program code means for positioning and generating one or both of the airport and runway symbols 110 further includes computer-readable program code means for updating the relative position information by regular sampling of the navigation data signals and generating the display control signals for the conformal airport and runway cues 110 as a function of the updated position information.

Optionally, the computer-readable program code means for positioning and generating one or both of the airport and runway also includes computer-readable program code means for updating the altitude information by regular sampling of the altitude data signals and varying the scaling of the conformal airport and runway cues 110 as a function of the aircraft's determined altitude above ground. The optional computer-readable program code means further includes computer-readable program code means for generating the display control signal informing the airport portion of the symbol 110 as a function of the altitude signal, e.g., when the aircraft is above about 1,000 feet AGL (above ground level).

These optional computer-readable program code means further include computer-readable program code means for generating the display control signal informing the runway portion of the symbol 110 while stopping generation of the airport portion of the display control signal as a function of the altitude signal, such that the runway portion of the symbol 110 is presented as the aircraft approaches the ground while the airport portion is removed.

Furthermore, according to the present invention, any one or more of the plurality of different computer-readable program code means for generating the different conformal symbology display control signals, including the conformal lateral deviation indicator cues 112, the conformal lateral path indication cues 114, conformal visual landmarks such as the conformal lateral current and next waypoint cues 116, 118, the conformal PLI (pitch limit indicator) cue 138, the conformal pitch scale cue 140, and the conformal runway/airport symbol 110, is optionally operated independently or in combination with any one or more of the other plurality of different computer-readable program code means for generating the different conformal symbology display control signals. Thus, the different conformal symbology displays can be presented on the display independently or in any combination with the other conformal symbology displays.

Optionally, the computer-readable program code means for retrieving and displaying in a wide-angle look-ahead mode intruder aircraft and collision avoidance information supplied by a TCAS (Traffic Alert Collision Avoidance System) or ACAS (Airborne Collision Avoidance System) or another aerial traffic detection and collision avoidance system. The TCAS repeater computer-readable program code means thus includes computer-readable program code means for retrieving all aerial traffic detection and collision avoidance information from the onboard TCAS equipment, or for retrieving at least a portion of the aerial traffic detection and collision avoidance information that is relevant to a current FOV presented by the display 100 of the invention. As discussed herein, the computer-readable program code means for rendering the conformal TCAS symbology utilizes either true one-to-one mapping, or conformal compressed symbology in which the information is rendered using mapping that is not a true one-to-one mapping whereby the information on the display is maximized. When the TCAS repeater computer-readable program code means includes computer-readable program code means for retrieving all aerial traffic detection and collision avoidance information from the onboard TCAS equipment, additional computer-readable program code means are included for isolating that portion of the information that lies within the scope of the illustration of the real world provided on the display 100, i.e., the FOV of the display 100. Additionally, the TCAS repeater computer-readable program code means includes computer-readable program code means for converting the 3-dimensional traffic data received from the TCAS equipment into a 2-dimensional wide-angle look-ahead view. Also included are computer-readable program code means for presenting the aerial traffic detection and collision avoidance information relevant to the current FOV of the display 110 conformally superimposed with the sky and ground portions 102, 104, shown in FIG. 3. The TCAS repeater computer-readable program code means thus causes the intruder aircraft to appear on the display 100 at approximately the same positions relative to the aircraft as they would appear, if visible, through the cockpit windscreen. Furthermore, the computer-readable program code means for presenting the aerial traffic detection and collision avoidance information on the display 110 include computer-readable program code means for using conventional TCAS horizontal display symbology and processes for depicting the intruding aircraft as discussed herein, thereby maximizing commonality with conventional TCAS navigation displays.

The TCAS repeater computer-readable program code means further includes computer-readable program code means for displaying conventional TCAS threat level indicators, the threat level of each intruder aircraft within the FOV presented by the display 100 being repeated in combination with the corresponding indicia or tag 202, 204, 206 that represents the intruder.

Computer-readable program code means are included for using conventional TCAS symbology to represent the relative altitude difference between the protected host aircraft and the intruder aircraft; whether the intruder is above or below the host aircraft; the two digit number that provides a visual cue as to the intruder aircraft's relative position; and the vertical arrow indicator of the intruder's altitude rate of change.

Furthermore, computer-readable program code means are included for regularly updating the relative position of the aerial traffic detection and collision avoidance information as a function of the protected host aircraft's real time position, heading and altitude.

When the protected host aircraft is provided with the improved four-antenna TCAS system as taught by U.S. Pat. No. 4,855,748, the TCAS repeater computer-readable program code means further includes computer-readable program code means for utilizing knowledge of the relative bearing of the intruding aircraft from the protected aircraft, in addition to the other data normally collected by standard TCAS equipment, to provide advisories for horizontal right or left turn maneuvers as well as for vertical maneuvers. Additional computer-readable program code means are included for repeating the TCAS advisories for horizontal right or left turn maneuvers as well as for vertical maneuvers.

Other computer-readable program code means are included for repeating the TCAS text displays wherein conditions of the TCAS are reported. The computer-readable program code means for repeating TCAS text displays being computer-readable program code means for repeating TCAS text displays in one or more of the areas represented by rectangular boxes 208, 210, 212, 214, 216 of the integrated display 100 of the invention.

Enhanced “T” Instrumentation

When the second computer-readable program code means is computer-readable program code means for generating of a plurality of the enhanced “T” instrument information presentation displays as one or more display control signals, the second computer-readable program code means for generating one or more of enhanced “T” instrument information displays for presentation on the cockpit display 100, the instrument information displays including without limitation: barometric and radio altitude instrumentation information displays; vertical speed instrumentation information displays; air speed instrumentation information displays; navigation instrumentation information displays including GPS altitude, course, heading, latitude and longitude instrumentation information displays; autopilot instrumentation information displays; radio glideslope instrumentation information displays; flap and gear position instrumentation information displays; and localizer receiver instrumentation information displays.

Thus, when the second computer-readable program code means is computer-readable program code means for generating one of the plurality of enhanced “T” instrument information display control signals, the second computer-readable program code means includes third computer-readable program code means for receiving barometric and radio altitude data signals; vertical speed data signals; air speed data signals; navigation data signals including GPS altitude, course, heading, latitude and longitude data signals; autopilot data signals; radio glideslope data signal; flap and gear position data signals; pitch attitude data signals; and localizer receiver data signals. The second computer-readable program code means further includes fourth computer-readable program code means for generating display control signals informing one or more instrument information display control signals, including one or more of an altitude display control signal; a vertical speed display control signal; an air speed display control signal; a navigation display control signal including one or more of GPS altitude, course, heading, latitude and longitude display control signals; autopilot display control signals; radio glideslope display control signals; flap and gear position display control signals; pitch attitude display control signals; and localizer receiver display control signals.

The fourth computer-readable program code means for generating one or more of the different display control signals further includes computer-readable program code means for dynamically emphasizing one or more of the different information displays by informing the one or more different information display control signal with a metamorphosis or transformation in appearance as a function of the current mode or phase of flight. The metamorphosis or transformation in appearance being any one or more of an animated size, font, shading and texture, as discussed herein.

The fourth computer-readable program code means for generating one or more of the different display control signals further includes computer-readable program code means for updating the instrument information by regular sampling of the different instrument data signals and varying the different instrument display control signals as a function of the updated instrument information.

Simulated Visual Glideslope Indicator

With reference to the computer-readable program code means for generating radio glideslope instrumentation information displays 148, the computer-readable program code means include computer-readable program code means for determining deviation from an ideal or preferred glideslope and generating a signal representative of the amount or degree of deviation.

The computer-readable program code means thus include computer-readable program code means for determining a global position from a received plurality of navigation data signals; computer-readable program code means for determining an altitude above ground level from one or more received navigation datum; computer-readable program code means for retrieving a plurality of airport information from the database 334 of airport information as a function of the predetermined aircraft position information; computer-readable program code means for determining coincidence between the predetermined aircraft position information combined with the predetermined aircraft altitude information and an ideal or preferred glideslope determined as a function of the predetermined airport information; and computer-readable program code means for generating and outputting an instrument information display control signal as a function of the predetermined coincidence between the predetermined aircraft position and altitude information and the ideal or preferred glideslope.

The computer-readable program code means for determining coincidence between the predetermined aircraft position and altitude information and the ideal or preferred glideslope may include means for computing the ideal or preferred glideslope as a function of the airport information. Alternatively, the computer-readable program code means for determining the coincidence may include computer-readable program code means for retrieving the glideslope as one of the plurality of airport information retrieved from the database 334 of airport information stored in the memory 326.

As discussed previously, the computer program product further includes computer-readable program code means for interpreting the instrument information display control signal output by the signal generating means as the simulated visual glideslope indicator display 148 embodied as a pattern of illuminated indicators on a cockpit display such as the display 100. For example, the computer-readable program code means may interpret the signal output by the fifth computer-readable program code means as a pattern of illuminated indicators that simulate on a cockpit display a known airport lighting aid, such as one of a simulated VASI or PAPI airport lighting aid or another standard airport lighting aid. The computer-readable program code means may further interpret the display control signal as a pattern of monochromatic or colored indicators that is presented on the display substantially conformally with the ground as viewed from the cockpit of the host aircraft.

Optionally, the computer-readable program code means may additionally interpret the display control signal as a needle or pointer indicator 148b for simulating on the display the traditional vertical deviation scale, and thereby provide additional information as to the degree of coincidence or deviation.

Pictographic Mode Awareness Display

With reference to the computer-readable program code means for generating the pictographic instrument information displays 134, the computer-readable program code means include computer-readable program code means for determining current and armed operational modes of the navigation and autopilot systems, as well as current vertical speed value and slope, and for generating a display control signal informing a pictographical representation symbolic of the current and armed modes of operation, and the current value and slope of vertical speed. The computer-readable program code means thus include computer-readable program code means enunciating current and armed operational modes of the navigation and autopilot systems, as well as current vertical speed value and slope. determine.

As described in U.S. patent application entitled PICTOGRAPHIC MODE AWARENESS DISPLAY FOR AIRCRAFT, which is incorporated herein by reference, and outlined briefly here, the computer-readable program code means for generating the pictographic instrument information displays 134 include computer-readable program code means for receiving a signal representative of a current mode of operation of one or more instrument systems, such as navigation and autopilot instrument systems; computer-readable program code means for determining a current mode of operation of the instrument system from the current mode of operation signal; and computer-readable program code means for generating and outputting a display control signal informing a pictographical representation symbolic of the current mode of operation.

Additional computer-readable program code means may include for either simultaneously or subsequently receiving the signal representative of a current vertical speed of the aircraft. The computer-readable program code means may also include computer-readable program code means for generating and outputting a display control signal informing an alphanumeric representation of the value of the current vertical speed in combination with the display control signal informing a pictographical representation symbolic of the current mode of operation.

The computer-readable program code means for generating the pictographic instrument information displays 134 include computer-readable program code means for receiving other aircraft information signals and for generating and outputting display control signals as described more fully in U.S. patent application for PICTOGRAPHIC MODE AWARENESS DISPLAY FOR AIRCRAFT.

While the preferred embodiment of the invention has been illustrated and described, it will be appreciated that various changes can be made therein without departing from the spirit and scope of the invention.

What is claimed is:

1. A display control device, comprising:
a processor structured for receiving samples of one or more signals reporting one or more different flight parameter data; and
one or more algorithms resident on the processor for generating as a function of the flight parameter information one or more display control signals for causing a display device to display one of a spatial flow symbology presentation, a conformal symbology presentation, and a plurality of instrument information presentations each having a dynamic transformation in appearance as a function of the flight parameter data.

2. The device of claim 1, further comprising a display generator coupled for receiving from the processor the display control signal and being structured for interpreting the display control signal to generate the spatial flow symbology, conformal symbology, and enhanced “T” instrument information presentations on the display.

3. The device of claim 1 wherein the one or more algorithms for generating the spatial flow symbology presentation further comprise one or more algorithms for generating one or more display control signals for causing a display device to display a field of view presenting a wide-angle view of an upper sky portion separated by a horizon line from a lower ground portion.

4. The device of claim 3 wherein the one or more algorithms for generating the spatial flow symbology presentation further comprise one or more algorithms for generating one or more display control signals for causing a display device to display one or more of texture, perspective, and color display features.

5. The device of claim 4 wherein the one or more algorithms for generating the spatial flow symbology presentation further comprise one or more algorithms for generating one or more display control signals for causing a display device to display color features in one or both of the sky portion and the ground portion of the display presentation.

6. The device of claim 4 wherein the one or more algorithms for generating the spatial flow symbology presentation further comprise one or more algorithms for generating one or more display control signals for causing a display device to display a graduated shading of one or both of the sky portion and the ground portion of the display presentation.

7. The device of claim 4 wherein the one or more algorithms for generating the spatial flow symbology presentation further comprise one or more algorithms for generating one or more display control signals for causing a display device to display a plurality of perspective lines over the ground portion of the display presentation.

8. The device of claim 7 wherein the one or more algorithms for generating the spatial flow symbology presentation further comprise one or more algorithms for generating one or more display control signals for causing a display device to display one or more texture cues on the ground portion of the display presentation.

9. The device of claim 1 wherein the one or more algorithms for generating the conformal symbology presentation further comprises one or more algorithms for generating, as a function of navigation information, one or more display control signals for causing a display device to display one or more of a conformal runway/airport symbol, a conformal lateral deviation indicator symbol in combination with a conformal lateral path indication symbol, a conformal lateral current waypoint symbol, a conformal next waypoint symbol, and conformal aerial traffic detection and collision avoidance symbols.

10. The device of claim 1 wherein the one or more algorithms for generating the plurality of instrument information presentations further comprise one or more algorithms for generating one or more dynamically emphasized flight parameter data indicator, the flight parameter data indicator being dynamically emphasized as a function of the flight parameter data.

11. The device of claim 10 wherein the one or more algorithms for generating one or more dynamically emphasized flight parameter data indicators further comprises one or more algorithms for dynamically generating the emphasized flight parameter data indicator having one or more of an enhanced size, font, shading and texture.

12. A display control device, comprising:
a processor coupled for receiving at a known sampling rate one or more different instrument data signals each reporting information about one or more different flight parameters; and
one or more algorithms resident on the processor and executable by the processor, the algorithms being structured to generate a plurality of display control signals as a function of the flight parameter information, the display control signals being structured to cause a display device to display one or more of:
graphical depictions symbolic of one or more of a plurality of spatial motion and energy cues of a type available in flying Visual Flight Rules,
navigation information as graphical depictions symbolic of one or more of a plurality of ground-based phenomena conformally as a function of the navigation information, and
a plurality of graphical depictions symbolic of the different instrument data, one or more of the plurality of graphical depictions being dynamically emphasized as a function of one of the different flight parameters.

13. The display control device of claim 12 wherein the one or more algorithms resident on and executable by the processor are structured to generate display control signals that cause a display device to display the graphical depictions of one or more of the spatial motion and energy cues, one or more of the ground-based phenomena, and one or more of the different instrument data.

14. The display control device of claim 13 wherein the one or more algorithms that are structured to generate display control signals that cause a display device to display the graphical depictions of the spatial motion and energy cues further comprise one or more algorithms that are structured to generate display control signals that cause a display device to display a wide-angle look-ahead field of view (FOV), the FOV having a sky portion and a ground portion separated by a horizon representation and being superimposed with one or more of texture, perspective, and color features.

15. The display control device of claim 14 wherein the one or more algorithms that are structured to generate display control signals that cause a display device to display the graphical depictions of the spatial motion and energy cues further comprise one or more algorithms that are structured to generate display control signals that cause a display device to display graded color features superimposed on one or both of the sky portion and the ground portion of the FOV

16. The display control device of claim 14 wherein the one or more algorithms that are structured to generate display control signals that cause a display device to display the graphical depictions of the spatial motion and energy cues further comprise one or more algorithms that are structured to generate display control signals that cause a display device to display perspective lines superimposed on the ground portion of the FOV.

17. The display control device of claim 14 wherein the one or more algorithms that are structured to generate display control signals that cause a display device to display the graphical depictions of the spatial motion and energy cues further comprise one or more algorithms that are structured to generate display control signals that cause a display device to display one or more texture cues on the ground portion of the FOV.

18. The display control device of claim 14 wherein the one or more algorithms that are structured to generate display control signals that cause a display device to display the graphical depictions of the conformal ground-based phenomena further comprise one or more algorithms that are structured to generate display control signals that cause a display device to display one or more of a conformal runway/airport symbol, conformal lateral deviation indicator lateral path indication symbols, a conformal lateral current waypoint symbol, a conformal next waypoint symbol, and a conformal aerial traffic symbol.

19. The display control device of claim 14 wherein the one or more algorithms that are structured to generate display control signals that cause a display device to display the graphical depictions of the instrument data further comprise one or more algorithms that are structured to generate display control signals that cause a display device to display one or more of an indicated air speed, an attitude, an altitude, a heading, a pictographic mode of flight indicator, a visual glideslope, and a navigation information.

20. The display control device of claim 19 wherein the one or more algorithms that are structured to generate display control signals that cause a display device to display the graphical depictions of the instrument data further comprise one or more algorithms that are structured to generate display control signals that cause a display device to display one of the graphical depictions of the instrument data as a dynamically emphasized graphical depiction as a function of one of a mode and a phase of flight.

21. The display control device of claim 20 wherein the one or more algorithms that are structured to generate display control signals that cause a display device to display the dynamically emphasized graphical depiction of instrument data further comprise one or more algorithms that are structured to generate display control signals that cause a display device to display the dynamically emphasized graphical depiction of instrument data as having a visual appearance different from a nominal visual appearance.

22. A display control device, comprising:
means for receiving samples of one or more signals reporting flight parameter information; and
means for generating on a display device one of a spatial flow symbology display presentation, a conformal symbology display presentation, and a plurality of instrument information display presentations each having a transformation in appearance as a function of the flight parameter information.

23. The device of claim 22 wherein the means for generating the spatial flow symbology display presentation further comprises means for generating one or more of texture, perspective, and color display features on the display device.

24. The device of claim 23, further comprising means for generating an expanded field of view (FOV) on the display device, the expanded FOV display presenting a wide-angle view of an upper sky portion separated by a horizon line from a lower ground portion.

25. The device of claim 24, further comprising means for generating color features in one or both of the sky portion and the ground portion of the spatial flow symbology display presentation.

26. The device of claim 24, further comprising means for generating a graded shading of one or both of the sky portion and the ground portion of the spatial flow symbology display presentation.

27. The device of claim 24, further comprising means for generating a plurality of perspective lines superimposed over the ground portion of the display presentation.

28. The device of claim 27, further comprising means for generating one or more texture cues on the ground portion of the spatial flow symbology display presentation.

29. The device of claim 22 wherein the means for generating the conformal symbology display presentation further comprises means for generating, as a function of navigation information, one or more of a conformal runway/airport symbol, a conformal lateral deviation indicator symbol and a conformal lateral path indication symbol, a conformal lateral current waypoint symbol, a conformal next waypoint symbol, and a conformal aerial traffic detection and collision avoidance information symbol.

30. The device of claim 22 wherein the means for generating the plurality of instrument information display presentations further comprises means for generating one or more dynamically emphasized flight parameter indicator, the flight parameter indicator being dynamically emphasized as a function of the flight parameter information.

31. The device of claim 30 wherein the means for generating one or more dynamically emphasized flight parameter indicator further comprises means for dynamically generating the emphasized flight parameter indicator having one or more of an enhanced size, font, shading and texture.

32. A display control device, comprising:
a means for receiving at intervals samples of one or more instrument signals reporting updated information about one or more different flight parameters; and
a means for generating on a display device as a function of the updated flight parameter information one or more of:
graphical depictions replicating one or more of a plurality of spatial motion and energy cues of a type available in conventional visual flying,
navigation information as graphical depictions symbolic of one or more of a plurality of ground-based phenomena in positions that conform to a view from a position and altitude consistent with the navigation information, and
a plurality of different instrument information presentations that are dynamically emphasized as a function of one of the different flight parameter information.

33. The display control device of claim 32 wherein the means for generating on a display device one or more of the graphical depictions, the navigation information, and the instrument information presentations further comprises means for generating each of the graphical depictions, the navigation information, and the instrument information presentations.

34. The display control device of claim 33 wherein the means for generating the graphical depictions replicating the spatial motion and energy cues on a display device further comprise means for generating on the display device a field of view (FOV) expanded a first angular degree in the horizontal and a second lesser angular degree in the vertical, the FOV having a sky portion and a ground portion separated by a horizon representation and being superimposed with one or more of texture, perspective, and color features.

35. The display control device of claim 34 wherein the means for generating the graphical depictions replicating the spatial motion and energy cues on a display device further comprise means for generating on the display device graded color features in one or both of the sky portion and the ground portion of the FOV.

36. The display control device of claim 34 wherein the means for generating the graphical depictions replicating the spatial motion and energy cues on a display device further comprise means for generating on the display device perspective lines on the ground portion of the FOV.

37. The display control device of claim 34 wherein the means for generating the graphical depictions replicating the spatial motion and energy cues on a display device further comprise means for generating on the display device one or more texture cues on the ground portion of the FOV.

38. The display control device of claim 34 wherein the means for generating the navigation information on a display device further comprise means for generating on the display device one or more of a conformal runway/airport symbol, a conformal lateral deviation indicator symbol and a conformal lateral path indication symbol, a conformal lateral current waypoint symbol, a conformal next waypoint symbol, and a conformal aerial traffic symbol.

39. The display control device of claim 34 wherein the means for generating the plurality of different instrument information presentations on a display device further comprise means for generating on the display device one or more of a presentation representative of an indicated air speed, a presentation representative of an attitude, a presentation representative of an altitude, a presentation representative of a heading, a pictographic presentation representative of a mode of flight, a presentation representative of a visual glideslope, and a presentation representative of navigation information.

40. The display control device of claim 39 wherein means for generating one or more of a presentations on the display device further comprise means for generating on the display device as a function of a mode or a phase of flight one of the presentations as a dynamically emphasized presentation.

41. The display control device of claim 40 wherein the means for generating one or more of the presentations as a dynamically emphasized presentation further comprise means for generating on the display device the dynamically emphasized presentation as having a visual appearance different from a nominal visual appearance.

42. An integrated display presentation for tactical flight path management, the integrated display presentation comprising:
a source of a plurality of instrument data signals each reporting flight parameter data;
a memory having a plurality of machine instructions stored therein, the machine instructions being executable by a processor for causing a display device to display one or more of a spatial flow symbology presentation, a conformal symbology presentation, and an instrument information presentation that exhibits a dynamic transformation in appearance as a function of the flight parameter data;
a processor coupled to receive the instrument data signals and coupled to the memory for retrieving the machine instructions, the processor being structured to operate the machine instructions for generating one or more of the spatial flow symbology presentation, the conformal symbology presentation, and the instrument information presentation, wherein:
the spatial flow symbology presentation is generated as a function of speed data,
the conformal symbology presentation is generated as a function of position, altitude and heading data, and
the dynamic transformation of the instrument information presentation is generated as a function of a mode or phase of flight data; and
a cockpit display being coupled to receive and display the spatial flow symbology, conformal symbology, and instrument information presentations.

43. The generator of claim 42 wherein the machine instructions for generating the spatial flow symbology presentation further comprise machine instructions for generating an expanded field of view having sky and ground portions, and including one or more of color, perspective and texture display features applied to one or both of the sky and ground portions for replicating a plurality of spatial motion and energy cues.

44. The generator of claim 43 wherein the machine instructions for generating the color display features further comprise machine instructions for generating a gradation in intensity of color in one or both of the sky and ground portions, the intensity generally decreasing with distance from an intersection of the sky and ground portions.

45. The generator of claim 43 wherein the machine instructions for generating the perspective display features further comprise machine instructions for generating a plurality of horizontal and longitudinal perspective lines that are superimposed on the ground portion, with the longitudinal perspective lines converging to a common vanishing point near an intersection of the sky and ground portions.

46. The generator of claim 42 wherein the machine instructions for generating the conformal symbology presentation further comprise machine instructions for generating one or more of a conformal runway/airport symbol, a conformal lateral deviation indicator symbol in combination with a conformal lateral path indication symbol, a conformal lateral current waypoint symbol, a conformal next waypoint symbol, and a conformal aerial traffic detection and collision avoidance information symbol.

47. The generator of claim 42 wherein the machine instructions for generating the dynamic transformation of the instrument information presentation further comprise machine instructions for generating a dynamic transformation of one or more of a size, font, shading and texture of the instrument information presentation.

48. The generator of claim 42 wherein the machine instructions for generating the dynamic transformation of the instrument information presentation further comprise machine instructions for generating a glideslope, comparing position and altitude data to the glideslope, and generating a signal representative of deviation of the position and altitude data from the glideslope.

49. The generator of claim 42 wherein the machine instructions for generating the dynamic transformation of the instrument information presentation further comprise machine instructions for generating a pictographic enunciator symbolizing a current operational state of an onboard instrument or instrument system.

50. The generator of claim 42 wherein the source of a plurality of instrument data signals each reporting flight parameter data further comprises a source of aerial traffic detection and collision avoidance information signals; and
wherein the machine instructions for causing a display device to display a conformal symbology presentation further comprises machine instructions executable by a processor for causing a display device to display a conformal symbology presentation of the aerial traffic detection and collision avoidance information signals.

51. A computer program residing on a computer usable storage medium, the computer program comprising:
computer-readable program code means for receiving at intervals one or more signals representative of updated flight parameter information; and
computer-readable program code means for generating and outputting a plurality of display control signals informing one of a spatial flow symbology presentation, a conformal symbology presentation, and a plurality of instrument information presentations each having a metamorphosis in appearance as a function of the updated flight parameter information.

52. The computer program of claim 51 wherein the computer-readable program code means for generating and outputting a plurality of display control signals informing the spatial flow symbology presentation further comprises computer-readable program code means for generating and outputting a plurality of display control signals informing one or more of texture, perspective, and color features.

53. The computer program of claim 52, further comprising computer-readable program code means for generating an expanded field of view (FOV) display control signal, the FOV display control signal informing a wide-angle view of the spatial flow symbology presentation having a sky portion and a ground portion, the sky and ground portions being separated by a horizon representation.

54. The computer program of claim 53, further comprising computer-readable program code means for generating coloration display control signals informing color features in one or both of the sky portion and the ground portion of the spatial flow symbology presentation.

55. The computer program of claim 53, further comprising computer-readable program code means for generating coloration display control signals informing a graded shading of one or both of the sky portion and the ground portion of the spatial flow symbology presentation.

56. The computer program of claim 53, further comprising computer-readable program code means for generating perspective display control signals informing perspective lines on the ground portion of the spatial flow symbology presentation.

57. The computer program of claim 56, further comprising computer-readable program code means for generating texture display control signals informing texture cues on the ground portion of the spatial flow symbology presentation.

58. The computer program of claim 51 wherein the computer-readable program code means for generating and outputting a plurality of display control signals informing the conformal symbology presentation further comprises computer-readable program code means for generating and outputting a plurality of display control signals informing one or more of a conformal runway/airport symbol, a conformal lateral deviation indicator symbol and a conformal lateral path indication symbol, a conformal lateral current waypoint symbol, a conformal next waypoint symbol, and a conformal aerial traffic information symbol.

59. The computer program of claim 51 wherein the computer-readable program code means for generating and outputting a plurality of display control signals informing the plurality of instrument information presentations further comprises computer-readable program code means for generating and outputting a plurality of display control signals informing one or more of an indicated air speed indicator, a ball/attitude indicator, an altitude indicator, a turn coordinator, a heading pointer, a pictographic information display, a simulated visual glideslope information display, and a Traffic Alert Collision Avoidance System (TCAS) navigation information display.

60. The computer program of claim 59 wherein the computer-readable program code means for generating and outputting a plurality of display control signals informing the plurality of instrument information presentations further comprises computer-readable program code means for generating emphasizing display control signals informing emphasis in one of the plurality of instrument information presentations as a function of the updated flight parameter information.

61. The computer program of claim 60 wherein the computer-readable program code means for generating emphasizing display control signals informing emphasis in one of the plurality of instrument information presentations further comprises computer-readable program code means for generating metamorphic display control signals informing a metamorphosis of the instrument information presentation.

62. The computer program of claim 61 wherein the computer-readable program code means for generating metamorphic display control signals informing metamorphosis of the instrument information presentation further comprises computer-readable program code means for generating display control signals informing a metamorphosis of one or more of size, font, shading and texture of the instrument information presentation

63. A computer program product, comprising:
a computer-usable medium having computer-readable code embodied therein for configuring a computer processor, the computer program product comprising:
computer-readable code configured to cause a computer processor to receive at intervals samples of one or more instrument signals reporting updated flight parameter information;
computer-readable code configured to cause a computer processor to generate at intervals and as a function of the updated flight parameter information a plurality of display control signals for causing a display device to display one of:
a spatial flow symbology presentation as a graphical presentation replicating one or more of a plurality of spatial motion and energy cues of a type available in conventional visual flying,
a conformal symbology presentation of navigation information as visual depictions symbolic of one or more of an aerial and a ground-based phenomenon as to conform to a view from a position and altitude consistent with the navigation information, and
a plurality of different enhanced “T” presentations of instrument information, one or more of the presentations of instrument information being dynamically emphasized as a function of the updated flight parameter information; and
computer-readable code configured to cause a computer processor to output the plurality of display control signals.

64. The computer program product of claim 63 wherein the computer-readable code is further configured to cause a computer processor to generate a plurality of display control signals for causing a display device to display each of the spatial flow symbology presentation, the conformal symbology presentation, and the enhanced “T” presentations.

65. The computer program product of claim 64 wherein the plurality of display control signals for causing a display device to display the spatial flow symbology presentation further comprise a plurality of display control signals for causing a display device to display a field of view (FOV) expanded at a wide angle in the horizontal and expanded in the vertical about one half the horizontal angle, and having a sky portion and a ground portion separated by a horizon representation and each being superimposed with one or more of texture, perspective, and color features

66. The computer program product of claim 65 wherein the plurality of display control signals for causing a display device to display the spatial flow symbology presentation further comprise a plurality of display control signals for causing a display device to display graded color features in one or both of the sky portion and the ground portion of the spatial flow symbology presentation.

67. The computer program product of claim 65 wherein the plurality of display control signals for causing a display device to display the spatial flow symbology presentation further comprise a plurality of display control signals for causing a display device to display perspective lines on the ground portion of the spatial flow symbology presentation.

68. The computer program product of claim 65 wherein the plurality of display control signals for causing a display device to display the spatial flow symbology presentation further comprise a plurality of display control signals for causing a display device to display texture cues on the ground portion of the spatial flow symbology presentation.

69. The computer program product of claim 65 wherein the plurality of display control signals for causing a display device to display the conformal symbology presentation further comprise a plurality of display control signals for causing a display device to display one or more of a conformal runway/airport symbol, a conformal lateral deviation indicator symbol in combination with a conformal lateral path indication symbol, a conformal lateral current waypoint symbol, a conformal next waypoint symbol, and a conformal aerial traffic information symbol.

70. The computer program product of claim 65 wherein the plurality of display control signals for causing a display device to display the plurality of different enhanced “T” presentations further comprise a plurality of display control signals for causing a display device to display one or more of a presentation representative of an indicated air speed, a presentation representative of an attitude, a presentation representative of an altitude, a presentation representative of a heading, a pictographic presentation representative of a mode of flight, a presentation representative of a visual glideslope, and a presentation representative of navigation information.

71. The computer program product of claim 70 wherein the plurality of display control signals for causing a display device to display the plurality of different enhanced “T” presentations further comprise a plurality of display control signals for causing a display device to display as a function of a mode or a phase of flight one of the presentations as a dynamically emphasized presentation.

72. The computer program product of claim 71 wherein the plurality of display control signals for causing a display device to display one or more of the presentations as a dynamically emphasized presentation further comprise a plurality of display control signals for causing a display device to display the presentation as having a visual appearance different from a nominal visual appearance.

73. A method for displaying flight parameter information, the method comprising:
receiving samples of one or more data signals reporting flight parameter information; and
in response to the flight parameter information, presenting on a display device one or more of a spatial flow symbology display, a conformal symbology display, and a plurality of instrument information displays, the appearance of each instrument information display transforming as a function of the flight parameter information.

74. The method of claim 73 wherein presenting the spatial flow symbology display further comprises presenting one or more of texture, perspective, and color display features on the display device.

75. The method of claim 74, further comprising presenting on the display device wide-angle sky and ground portions separated by a horizon line.

76. The method of claim 75, further comprising presenting color features in one or both of the sky portion and the ground portion of the display.

77. The method of claim 75, further comprising presenting a graded shading of one or both of the sky portion and the ground portion of the display.

78. The method of claim 75, further comprising presenting a plurality of perspective lines over the ground portion of the display.

79. The method of claim 78, further comprising presenting one or more texture cues on the ground portion of the display.

80. The method of claim 73 wherein presenting the conformal symbology display further comprises presenting on the display device, as a function of navigation information, one or more of a conformal runway/airport symbol, a conformal lateral deviation indicator symbol and a conformal lateral path indication symbol, a conformal lateral current waypoint symbol, and a conformal next waypoint symbol, and a conformal aerial traffic information symbol.

81. The method of claim 73 wherein presenting the plurality of instrument information displays further comprises presenting one or more dynamically emphasized flight parameter indicators as a function of the flight parameter information.

82. The method of claim 81 wherein presenting one or more dynamically emphasized flight parameter indicators further comprises dynamically enhancing one or more of an enhanced size, font, shading and texture of the flight parameter indicator.
